(19) United States
(12) Patent Application Publication
(10) Pub. No.: US 2025/0252654 A1
(43) Pub. Date: Aug. 7, 2025

(54) THREE-DIMENSIONAL MODEL GENERATION METHOD, THREE-DIMENSIONAL MODEL GENERATION DEVICE, AND NON-TRANSITORY COMPUTER READABLE RECORDING MEDIUM STORING THREE-DIMENSIONAL MODEL GENERATION PROGRAM

(71) Applicant: Panasonic Intellectual Property Management Co., Ltd., Osaka (JP)

(72) Inventors: Minami NAKA, Osaka (JP); Kensho Teranishi, Osaka (JP); Tadamasa Toma, Osaka (JP)

(21) Appl. No.: 19/186,938

(22) Filed: Apr. 23, 2025

Related U.S. Application Data
(63) Continuation of application No. PCT/JP2023/037571, filed on Oct. 17, 2023.
(60) Provisional application No. 63/420,170, filed on Oct. 28, 2022.

(30) Foreign Application Priority Data
Sep. 5, 2023 (JP) 2023-143811

(51) Int. Cl. G06T 15/04; G06T 7/13; G06T 17/20

(52) U.S. Cl. CPC G06T 15/04; G06T 7/13; G06T 17/20; G06T 2210/56; G06T 2210/62

(57) ABSTRACT

A three-dimensional model generation method includes generating point cloud data of a three-dimensional model indicating a three-dimensional shape of a subject on a basis of a plurality of images arranged in ascending order of distance from a position of a camera to the subject, generating mesh data from the point cloud data, generating a plurality of texture candidate images to be pasted to a plurality of polygons constituting the mesh data on a basis of an image in which distances between the plurality of polygons constituting the mesh data and the image are shortest among images having pixel regions corresponding to the mesh data, and pasting an image of a region on the plurality of texture candidate images corresponding to a position of each of the plurality of polygons as a texture to each of the plurality of polygons.

### FIELD OF INVENTION

The present disclosure relates to a technique for generating a texture-mapped three-dimensional model.

### BACKGROUND ART

In recent years, there is a technique for measuring a three-dimensional shape of a subject using a multi-viewpoint image obtained by capturing the subject such as a person or a building from multiple viewpoints to generate a three-dimensional model of the subject (see, for example, Patent Literature 1).

In the technique disclosed in Patent Literature 1, after camera parameters (position, orientation, focal distance in pixel, lens distortion, and the like of the camera) when each image constituting the multi-viewpoint image is captured are geometrically estimated, each pixel on each image is projected on a three-dimensional space using the estimated camera parameters to generate a three-dimensional model of a subject.

However, in the conventional technique described above, pasting a texture to a three-dimensional model is not considered, and further improvement is required.
Patent Literature 1: JP 2015-056142 A

### SUMMARY OF THE INVENTION

The present disclosure has been made to solve the above problem, and an object thereof is to provide a technique capable of pasting a texture with high resolution to a plurality of polygons of a three-dimensional model and improving accuracy of a texture-mapped three-dimensional model.

A three-dimensional model generation method according to the present disclosure is a three-dimensional model generation method in a computer, the method including generating point cloud data of a three-dimensional model indicating a three-dimensional shape of a subject on a basis of a plurality of images arranged in ascending order of distance from a position of a camera to the subject, generating mesh data from the point cloud data, generating a plurality of texture candidate images to be pasted to a plurality of polygons constituting the mesh data on a basis of an image in which distances between the plurality of polygons constituting the mesh data and the image are shortest among images having pixel regions corresponding to the mesh data, and pasting an image of a region on the plurality of texture candidate images corresponding to a position of each of the plurality of polygons as a texture to each of the plurality of polygons.

According to the present disclosure, it is possible to paste a texture having high resolution to a plurality of polygons of a three-dimensional model and to improve accuracy of a texture-mapped three-dimensional model.

### BRIEF DESCRIPTION OF THE DRAWINGS

FIG. 1 is a diagram for describing an outline of a three-dimensional model generation method according to a first embodiment.

FIG. 2 is a block diagram illustrating a characteristic configuration of a three-dimensional model generation device according to the first embodiment.

FIG. 3 is a block diagram illustrating a detailed configuration of a model generation part included in the three-dimensional model generation device according to the first embodiment.

FIG. 4 is a block diagram illustrating a detailed configuration of a texture mapping part included in the three-dimensional model generation device according to the first embodiment.

FIG. 5 is a flowchart illustrating processing executed by the three-dimensional model generation device according to the first embodiment.

FIG. 6 is a diagram for describing a first example of a capturing order of a camera.

FIG. 7 is a diagram for describing a first example of a frame order determined by the three-dimensional model generation device with respect to the capturing order of the camera.

FIG. 8 is a diagram for describing a second example of the capturing order of the camera.

FIG. 9 is a diagram for describing a second example of the frame order determined by the three-dimensional model generation device with respect to the capturing order of the camera.

FIG. 10 is a diagram for describing a third example of the capturing order of the camera.

FIG. 11 is a diagram for describing a third example of the frame order determined by the three-dimensional model generation device with respect to the capturing order of the camera.

FIG. 12 is a diagram for describing a fourth example of the capturing order of the camera.

FIG. 13 is a diagram for describing a fourth example of the frame order determined by the three-dimensional model generation device with respect to the capturing order of the camera.

FIG. 14 is a flowchart illustrating an example of generation processing of a frame set executed by the three-dimensional model generation device according to the first embodiment.

FIG. 15 is a flowchart illustrating three-dimensional model generation processing executed by the three-dimensional model generation device according to the first embodiment.

FIG. 16 is a diagram for describing a processing position of a frame in generation processing executed by a model generation part included in the three-dimensional model generation device according to the first embodiment.

FIG. 17 is a diagram for describing a change in a capturing position by the camera.

FIG. 18 is a diagram for describing a change in a capturing range by the camera.

FIG. 19 is a diagram for describing a processing procedure in which a three-dimensional model generation part generates a three-dimensional model.

FIG. 20 is a flowchart illustrating texture candidate image generation processing executed by the three-dimensional model generation device according to the first embodiment.

FIG. 21 is a diagram for describing texture candidate image generation processing executed by a texture candidate image generation part included in the three-dimensional model generation device according to the first embodiment.

FIG. 22 is a flowchart illustrating texture image pasting processing executed by the three-dimensional model generation device according to the first embodiment.

FIG. 23 is a diagram for describing texture image pasting processing executed by a texture image pasting part included in the three-dimensional model generation device according to the first embodiment.

FIG. 24 is a block diagram illustrating a characteristic configuration of a three-dimensional model generation device according to a second embodiment.

FIG. 25 is a block diagram illustrating a characteristic configuration of a model generation part included in the three-dimensional model generation device according to the second embodiment.

FIG. 26 is a flowchart illustrating three-dimensional model generation processing executed by the three-dimensional model generation device according to the second embodiment.

FIG. 27 is a diagram for describing a processing position of a frame in processing executed by an update part included in the three-dimensional model generation device according to the second embodiment.

### DETAILED DESCRIPTION

### (Knowledge Underlying Present Disclosure)

In a three-dimensional model generation (restoration) technique, a three-dimensional shape of a subject is restored from a plurality of frames (images) continuously captured. The subject restored in a virtual three-dimensional space is called a three-dimensional model. The three-dimensional model of the subject is a set of points indicating respective three-dimensional positions of a plurality of points on the subject appearing in each of a plurality of two-dimensional images captured from a plurality of viewpoints. By pasting the two-dimensional image of the subject as a texture to the three-dimensional model, a more realistic three-dimensional shape of the subject can be restored.

However, in the above-described conventional technique, pasting a texture to a three-dimensional model is not considered.

In order to solve the above problem, a technique below is disclosed.
(1) A three-dimensional model generation method according to one aspect of the present disclosure is a three-dimensional model generation method in a computer, the method including generating point cloud data of a three-dimensional model indicating a three-dimensional shape of a subject on a basis of a plurality of images arranged in ascending order of distance from a position of a camera to the subject, generating mesh data from the point cloud data, generating a plurality of texture candidate images to be pasted to a plurality of polygons constituting the mesh data on a basis of an image in which distances between the plurality of polygons constituting the mesh data and the image are shortest among images having pixel regions corresponding to the mesh data, and pasting an image of a region on the plurality of texture candidate images corresponding to a position of each of the plurality of polygons as a texture to each of the plurality of polygons.

With this method, the plurality of texture candidate images to be pasted to the plurality of polygons constituting the three-dimensional model is generated on the basis of the plurality of images arranged in ascending order of distance from a position of a camera to the subject. An image captured by a camera closer to the subject has higher accuracy, that is, higher resolution. Thus, a texture with high resolution can be pasted to the plurality of polygons of the three-dimensional model, and accuracy of a texture-mapped three-dimensional model can be improved.

In addition, information at the time of generating the point cloud data is used, so that image selection processing at the time of texture mapping is unnecessary, and the processing amount can be expected to be reduced.
(2) In the three-dimensional model generation method according to (1), the generating the plurality of texture candidate images may include generating a texture candidate image in which a region other than a region including a plurality of pixels corresponding to a point cloud in an image used to generate the point cloud data has been subjected to mask processing.

With this configuration, by not using the region that has been subjected to the mask processing on the texture candidate image as the texture and using the region that has not been subjected to the mask processing on the texture candidate image as the texture, the texture to be pasted to the polygon can be easily determined, and the processing time required to select the texture to be pasted to the polygon can be shortened.
(3) In the three-dimensional model generation method according to (2), the region including the plurality of pixels may be a region surrounded by the plurality of pixels.

With this configuration, since a region other than the region surrounded by the plurality of pixels is subjected to the mask processing, the region to be subjected to the mask processing can be easily determined, and the processing time required for the mask processing can be shortened.
(4) In the three-dimensional model generation method according to (2), the region including the plurality of pixels may be a region surrounded by an edge detected by edge detection of peripheries of the plurality of pixels or a region in a plane estimated by plane estimation of peripheries of the plurality of pixels.

With this configuration, an image not only in the region surrounded by the plurality of pixels but also in a peripheral region of the plurality of pixels can be used as a texture, so that the texture can be pasted to more polygons from one texture candidate image, and the processing time for pasting the texture on the plurality of polygons can be shortened.
(5) In the three-dimensional model generation method according to any one of (2) to (4), the mask processing may include processing of making a region other than a region including the plurality of pixels in the image used to generate the point cloud data transparent.

With this configuration, by setting the region including the plurality of pixels in the image used to generate the point cloud data to be opaque and setting a region other than the region to be transparent, the mask processing can be easily performed, and the processing time required for the mask processing can be shortened.
(6) In the three-dimensional model generation method according to any one of (2) to (4), the mask processing may include processing of filling a region other than a region including the plurality of pixels in the image used to generate the point cloud data with a predetermined color.

With this configuration, by filling the region other than the region including the plurality of pixels in the image used to generate the point cloud data with the predetermined color, the mask processing can be easily performed, and the processing time required for the mask processing can be shortened.
(7) In the three-dimensional model generation method according to any one of (2) to (6), the pasting the image may include determining whether or not the region on the texture candidate images corresponding to the position of each of the plurality of polygons has been subjected to the mask processing, and pasting an image of the region determined not to have been subjected to the mask processing as the texture on the polygon.

With this configuration, since the image of the region determined not to have been subjected to the mask processing is pasted to the polygon as a texture, the texture to be pasted to the polygon can be easily determined, and the processing time required to select the texture to be pasted to the polygon can be shortened.
(8) In the three-dimensional model generation method according to any one of (1) to (6), the pasting the image may include determining whether or not each of the plurality of polygons is visible from the position of the camera in the texture candidate image, and pasting an image of a region on the texture candidate image corresponding to a position of the polygon determined to be visible from the position of the camera as the texture on the polygon.

With this configuration, since the texture is pasted only to the polygon visible from the position of the camera of the texture candidate image among the plurality of polygons constituting the mesh data, the processing time required to select the texture to be pasted to the polygon can be shortened.

Further, the present disclosure can be implemented not only as a three-dimensional model generation method for executing the characteristic processing as described above, but also as a three-dimensional model generation device or the like having a characteristic configuration corresponding to the characteristic processing executed by the three-dimensional model generation method. Further, the present disclosure can also be implemented as a computer program that causes a computer to execute characteristic processing included in such a three-dimensional model generation method. Therefore, other aspects below can also achieve effects similar to those of the above three-dimensional model generation method.
(9) A three-dimensional model generation device according to another aspect of the present disclosure includes a three-dimensional model generation part that generates point cloud data of a three-dimensional model indicating a three-dimensional shape of a subject on a basis of a plurality of images arranged in ascending order of distance from a position of a camera to the subject, a mesh data generation part that generates mesh data from the point cloud data, a texture candidate image generation part that generates a plurality of texture candidate images to be pasted to a plurality of polygons constituting the mesh data on a basis of an image in which distances between the plurality of polygons constituting the mesh data and the image are shortest among images having pixel regions corresponding to the mesh data, and an image pasting part that pastes an image of a region on the plurality of texture candidate images corresponding to a position of each of the plurality of polygons as a texture to each of the plurality of polygons.
(10) A three-dimensional model generation program according to another aspect of the present disclosure causes a computer to function to generate point cloud data of a three-dimensional model indicating a three-dimensional shape of a subject on a basis of a plurality of images arranged in ascending order of distance from a position of a camera to the subject, generate mesh data from the point cloud data, generate a plurality of texture candidate images to be pasted to a plurality of polygons constituting the mesh data on a basis of an image in which distances between the plurality of polygons constituting the mesh data and the image are shortest among images having pixel regions corresponding to the mesh data, and paste an image of a region on the plurality of texture candidate images corresponding to a position of each of the plurality of polygons as a texture to each of the plurality of polygons.
(11) A non-transitory computer-readable recording medium according to another aspect of the present disclosure records a three-dimensional model generation program, and the three-dimensional model generation program causes a computer to function to, generate point cloud data of a three-dimensional model indicating a three-dimensional shape of a subject on a basis of a plurality of images arranged in ascending order of distance from a position of a camera to the subject, generate mesh data from the point cloud data, generate a plurality of texture candidate images to be pasted to a plurality of polygons constituting the mesh data on a basis of an image in which distances between the plurality of polygons constituting the mesh data and the image are shortest among images having pixel regions corresponding to the mesh data, and paste an image of a region on the plurality of texture candidate images corresponding to a position of each of the plurality of polygons as a texture to each of the plurality of polygons.

Hereinafter, embodiments of the present disclosure will be described with reference to the accompanying drawings. Note that each of embodiments to be described below illustrates a specific example of the present disclosure. Numerical values, shapes, constituent elements, steps, order of steps, and the like described in the embodiments below are merely examples, and are not intended to limit the present disclosure. Further, a constituent element not described in an independent claim representing a highest concept among constituent elements in the embodiments below is described as an optional constituent element. In all the embodiments, respective contents can be combined.

### First Embodiment

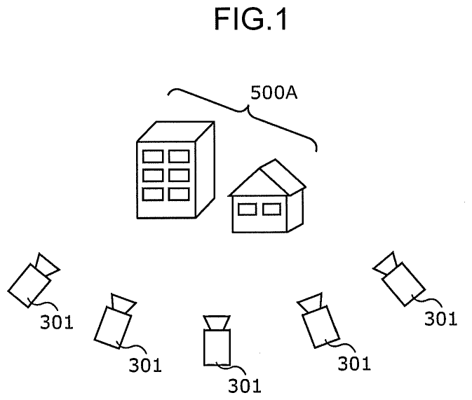

First, an outline of a three-dimensional model generation method according to the first embodiment will be described with reference to FIG. 1.

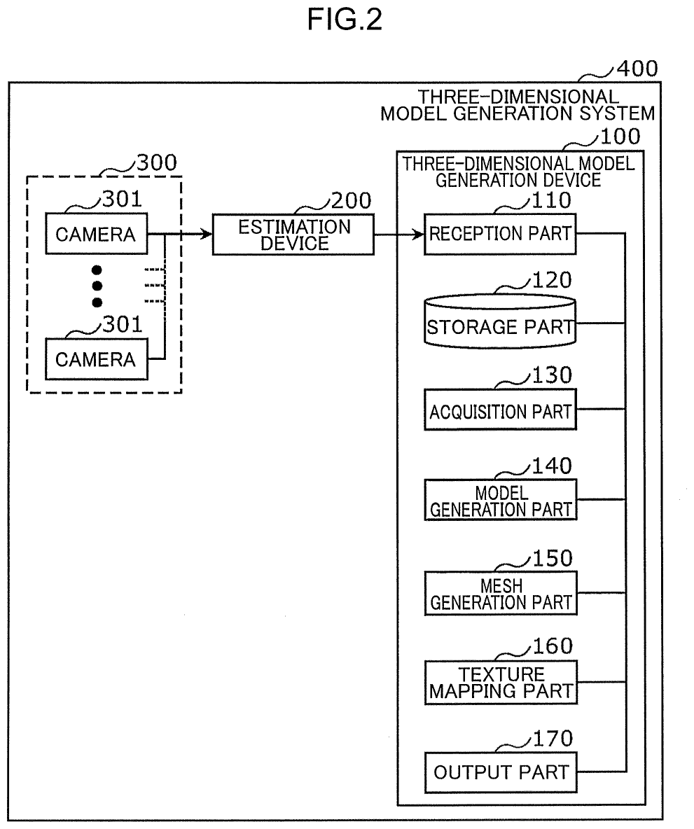

FIG. 1 is a diagram for describing an outline of a three-dimensional model generation method according to a first embodiment. FIG. 2 is a block diagram illustrating a characteristic configuration of a three-dimensional model generation device 100 according to the first embodiment.

A three-dimensional model generation system 400 includes a camera group 300 including cameras 301 that are a plurality of imaging devices that captures a predetermined region, an estimation device 200 that estimates positions and attitudes of the plurality of cameras 301 on the basis of a plurality of frames (in other words, image or video data) captured by the plurality of cameras 301, and a three-dimensional model generation device 100 to which the plurality of frames captured by the plurality of cameras 301 and an estimation result of the estimation device 200 are input.

Note that the attitude of the camera 301 indicates at least one of an imaging direction of the camera 301 or an inclination of the camera 301.

The predetermined region is a region including a stationary object or a moving body such as a person, or both of them. In other words, the predetermined region is, for example, a region including at least one of a stationary object that is stationary or a moving object that is moving as a subject. Examples of the predetermined region including the stationary object and the moving object include a sports game such as a basketball game, and a city where a person or a car is present. Note that the predetermined region may be a scene including not only a specific object that is a subject but also a landscape or the like. FIG. 1 illustrates a case where subject 500A is a house. In addition, hereinafter, not only a specific object to be a subject but also a predetermined region including a landscape or the like is simply referred to as a subject.

Each of the plurality of cameras 301 captures a subject and outputs a plurality of captured frames to the estimation device 200. In the present first embodiment, the camera group 300 includes two or more cameras 301. Further, the plurality of cameras 301 captures the same subject from different viewpoints.

Note that the three-dimensional model generation system 400 may include a plurality of cameras 301 or may include one camera 301. For example, the three-dimensional model generation system 400 may cause one camera 301 to perform capturing so as to generate a plurality of frames (in other words, the multi-viewpoint video data) having different viewpoints from each other while moving one camera 301. That is, each of the plurality of frames is a frame captured (generated) by the camera 301 in which at least one of the position or the attitude of the camera 301 is different from each other.

In addition, the camera 301 may be a camera that generates a two-dimensional image or a camera including a three-dimensional measurement sensor that generates a three-dimensional model. In the present first embodiment, each of the plurality of cameras 301 is a camera that generates a two-dimensional image.

The one or more cameras 301 are connected to the estimation device 200 itself or a hub, not illustrated, such as a communication device or a server in a wired or wireless manner so that a frame captured by each camera can be input to the estimation device 200.

Note that frames captured by one or more cameras 301 may be output in real time, or the frames may be output from an external storage device such as a memory or a cloud server after being recorded once.

In addition, each of the one or more cameras 301 may be a fixed camera such as a monitoring camera, may be a mobile camera such as a video camera, a smartphone, or a wearable camera, or may be a mobile camera such as a drone with a capturing function.

The estimation device 200 is a device that estimates the positions, attitudes, and camera parameters of the plurality of cameras 301 on the basis of a plurality of frames acquired from one or more cameras 301.

Here, the camera parameters are parameters indicating the characteristics of the camera 301, and are one or more parameters including internal parameters including a focal distance, an image center, and the like of the camera 301 and external parameters indicating the position (more specifically, the three-dimensional position) and the attitude of the camera 301.

Note that an estimation method by which the estimation device 200 estimates the position and attitude of the camera 301 is not particularly limited. The estimation device 200 estimates the positions and attitudes of the plurality of cameras 301 using, for example, visual simultaneous localization and mapping (visual-SLAM) technique. Alternatively, the estimation device 200 estimates the position and attitude of each of the one or more cameras 301 using, for example, structure-from-motion technique.

Further, the estimation device 200 calculates the distance between the camera 301 and the subject as a camera parameter on the basis of the position and attitude of the camera 301 estimated using the above-described technique, for example. Note that the three-dimensional model generation system 400 may include a distance measuring sensor, and the distance between the camera 301 and the subject may be measured using the distance measuring sensor.

The estimation device 200 is connected to the three-dimensional model generation device 100 itself or a hub, not illustrated, such as a communication device or a server in a wired or wireless manner so that the plurality of frames and the estimation result received from the camera 301 can be input to the three-dimensional model generation device 100.

The estimation device 200 inputs the plurality of frames received from the camera 301 and the estimated camera parameters to the three-dimensional model generation device 100.

Note that the estimation result of the estimation device 200 may be output in real time, or after the estimation result is once recorded in an external storage device such as a memory or a cloud server, the estimation result may be output from the external storage device.

In addition, the three-dimensional model generation device 100 may store camera parameters in advance. In this case, the three-dimensional model generation system 400 need not include the estimation device 200. Further, the plurality of cameras 301 may be connected to the three-dimensional model generation device 100 so as to be able to communicate therewith in a wireless or wired manner.

In addition, the plurality of frames captured by the camera 301 may be directly input to the three-dimensional model generation device 100. In this case, the camera 301 is connected to the three-dimensional model generation device 100 itself or a hub, not illustrated, such as a communication device or a server, for example, in a wired or wireless manner.

The estimation device 200 includes at least a computer system including, for example, a control program, a processing circuit such as a processor or a logic circuit that executes the control program, and a recording device such as an internal memory or an accessible external memory that stores the control program.

The three-dimensional model generation device 100 is a device that generates a model of a subject in a (virtual) three-dimensional space on the basis of the position, attitude, and camera parameters of each of the plurality of cameras 301 and the plurality of frames, that is, executes three-dimensional model generation processing.

Here, the plurality of frames is a multi-viewpoint video. The multi-viewpoint video is a video in which a subject existing in a real space is captured while moving the camera 301 or at different viewpoints by the plurality of cameras 301. That is, the plurality of frames is images having different viewpoints. In other words, the estimation device 200 estimates the positions, attitudes (imaging directions), and camera parameters of the plurality of cameras 301 on the basis of a plurality of frames having different viewpoints acquired from one or more cameras 301.

Note that the subject whose shape is restored, that is, generated in the virtual three-dimensional space from the frame in which the real object of the subject is captured is referred to as a three-dimensional model. The three-dimensional model of the subject is a set of points (point cloud) indicating respective three-dimensional positions of a plurality of points on the subject appearing in each of a plurality of multi-viewpoint two-dimensional images, that is, a plurality of two-dimensional images in which at least one of the position or the attitude of the camera 301 that has captured the subject is different.

The three-dimensional position is represented by, for example, ternary information including an X component, a Y component, and a Z component of a three-dimensional space including an X axis, a Y axis, and a Z axis orthogonal to each other. Note that the information included in the plurality of points indicating the three-dimensional position may include not only the three-dimensional position (that is, information indicating coordinates) but also information indicating the color of each point, information indicating a surface shape of each point and a periphery thereof, and the like.

The three-dimensional model generation device 100 includes at least a computer system including, for example, a control program, a processing circuit such as a processor or a logic circuit that executes the control program, and a recording device such as an internal memory or an accessible external memory that stores the control program. Note that the three-dimensional model generation device 100 may be implemented by, for example, hardware implementation by a processing circuit, execution of a software program held in a memory by the processing circuit or distributed from an external server, or a combination of the hardware implementation and the software implementation. [Configuration of three-dimensional model generation device]

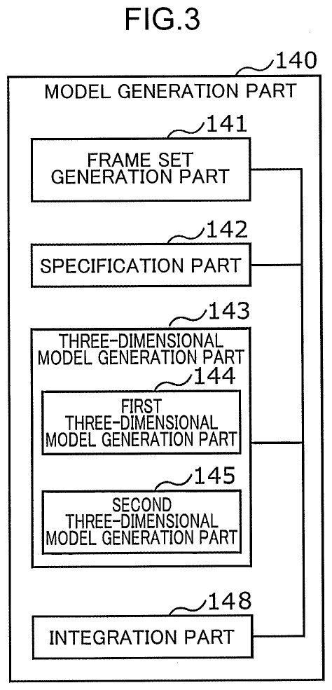

Next, a configuration of the three-dimensional model generation device 100 will be described in detail with reference to FIGS. 2 and 3.

The three-dimensional model generation device 100 is a device that generates a three-dimensional model from a plurality of frames. The three-dimensional model generation device 100 includes a reception part 110, a storage part 120, an acquisition part 130, a model generation part 140, a mesh generation part 150, a texture mapping part 160, and an output part 170.

The reception part 110 receives, from the estimation device 200, a plurality of images captured by the plurality of cameras 301, and the position, attitude, and camera parameters of each of the plurality of cameras 301 estimated by the estimation device 200. The reception part 110 is, for example, a communication interface for communicating with the estimation device 200. In a case where the three-dimensional model generation device 100 and the estimation device 200 wirelessly communicate with each other, the reception part 110 includes, for example, an antenna and a wireless communication circuit. Alternatively, when the three-dimensional model generation device 100 and the estimation device 200 perform wired communication, the reception part 110 includes, for example, a connector connected to a communication line.

The reception part 110 outputs, to the storage part 120, a received plurality of frames captured by the plurality of cameras 301 and the position, attitude, and camera parameters of each of the one or more cameras 301 estimated by the estimation device 200.

The storage part 120 is a memory that stores the plurality of frames captured by the one or more cameras 301 and received by the reception part 110, and the position, attitude, and camera parameters of each of the one or more cameras 301 estimated by the estimation device 200. The storage part 120 stores, for example, a control program executed by each processing part included in the three-dimensional model generation device 100.

The storage part 120 is implemented by, for example, a hard disk drive (HDD), a flash memory, or the like.

The acquisition part 130 is a processing part that acquires, from the storage part 120, the plurality of frames captured by one or more cameras 301 and the position, attitude, and camera parameters of each of the one or more cameras 301 estimated by the estimation device 200, which are stored in the storage part 120, and outputs the frames and the position, attitude, and camera parameters to the model generation part 140.

Note that the reception part 110 may directly output the plurality of frames received from the one or more cameras 301 and the position, attitude, and camera parameters of each of the one or more cameras 301 estimated by the estimation device 200 to the model generation part 140.

The model generation part 140 is a processing part that generates a three-dimensional model of the subject on the basis of the plurality of images captured by the plurality of cameras 301 input from the acquisition part 130 and the position, attitude, and camera parameters of each of the plurality of cameras 301 estimated by the estimation device 200. The model generation part 140 generates point cloud data of the three-dimensional model indicating the three-dimensional shape of the subject on the basis of the plurality of images arranged in ascending order of distance from the position of the camera 301 to the subject.

FIG. 3 is a block diagram illustrating a detailed configuration of the model generation part 140 included in the three-dimensional model generation device 100 according to the first embodiment.

The model generation part 140 includes a frame set generation part 141, a specification part 142, a three-dimensional model generation part 143, and an integration part 148.

The frame set generation part 141 is a processing part that generates a frame set selected from a plurality of frames (imaging frames) on the basis of the position and attitude of the camera 301 at each time of capturing the plurality of frames (imaging frames), that is, a frame set including a plurality of frames included in the plurality of imaging frames. There is one piece of data (position and attitude data) indicating the position and attitude of the camera for one frame. That is, the frame set generation part 141 generates a frame set including frames selected from a plurality of frames on the basis of a plurality of pieces of position and attitude data indicating the position and attitude of the camera 301 at each time of capturing the plurality of frames. The frame set includes a plurality of first frames and one second frame. The first frames are frames for a first three-dimensional model generation part 144 to generate a first three-dimensional model. The second frame is a frame for generating a second three-dimensional model.

Note that at least one second frame may be the same as at least one frame among the plurality of first frames. Alternatively, the first frame and the second frame may be different from each other.

For example, the frame set generation part 141 generates a multi-viewpoint frame set (hereinafter, also simply referred to as a frame set) in which a plurality of frames is rearranged in a predetermined order on the basis of the plurality of frames captured by one or more cameras 301 input from the acquisition part 130 and the position, attitude, and camera parameters of each of the one or more cameras 301 estimated by the estimation device 200.

The specification part 142 is a processing part that projects the first three-dimensional model onto at least one second frame and specifies a plurality of unprojected pixels on which the first three-dimensional model has not been projected in at least one second frame. Specifically, the specification part 142 projects a first three-dimensional model generated by the first three-dimensional model generation part 144 to be described later onto at least one second frame included in a plurality of frames excluding the first frame, and specifies an unprojected pixel that is a pixel on which the first three-dimensional model has not been projected, in at least one second frame on which the first three-dimensional model has been projected. More specifically, the specification part 142 projects the already generated three-dimensional model (hereinafter, also referred to as an existing three-dimensional model) onto the frames in the order of the frame set generated by the frame set generation part 141. For example, by projecting the existing three-dimensional model onto the frame, the specification part 142 specifies an unprojected pixel on which the three-dimensional model has not been projected among pixels of the frame on which the three-dimensional model has been projected. That is, the specification part 142 specifies a pixel of a difference between the existing three-dimensional model and the frame.

The three-dimensional model generation part 143 is a processing part that generates a three-dimensional model from a plurality of frames. For example, the three-dimensional model generation part 143 first generates a three-dimensional model (first three-dimensional model), and newly generates a three-dimensional model (hereinafter, also referred to as a second three-dimensional model or a new three-dimensional model) for pixels on which the three-dimensional model has not been projected, in a frame on which the generated three-dimensional model has been projected by the specification part 142. For example, the three-dimensional model generation part 143 outputs the new three-dimensional model to the storage part 120. The storage part 120 stores the new three-dimensional model input from the three-dimensional model generation part 143.

The three-dimensional model generation part 143 includes the first three-dimensional model generation part 144 and a second three-dimensional model generation part 145.

The first three-dimensional model generation part 144 is a processing part that generates a first three-dimensional model of a predetermined region from the plurality of first frames. Specifically, the first three-dimensional model generation part 144 generates the first three-dimensional model of the subject from a plurality of frames (first frames) among the plurality of frames.

The second three-dimensional model generation part 145 is a processing part that generates the second three-dimensional model on the basis of the unprojected pixels specified by the specification part 142.

For example, the specification part 142 further projects the existing three-dimensional model on a frame on which the three-dimensional model is not yet projected in the frame set, and specifies an unprojected pixel on which the three-dimensional model has not been projected in the frame. Here, when the second three-dimensional model generation part 145 has not generated the second three-dimensional model, the existing three-dimensional model is the first three-dimensional model. Further, when the second three-dimensional model generation part 145 generates the second three-dimensional model, the existing three-dimensional model includes the first three-dimensional model and the second three-dimensional model generated by the second three-dimensional model generation part 145. The second three-dimensional model generation part 145 further generates a new three-dimensional model for an unprojected pixel on which the existing three-dimensional model has not been projected in the frame on which the existing three-dimensional model has been projected by the specification part 142.

The specification part 142 and the three-dimensional model generation part 143 repeatedly project the three-dimensional model onto the frame in the order of the frame set, thereby specifying unprojected pixels on which the three-dimensional model has not been projected in the frame, and generating the three-dimensional model for the specified unprojected pixels.

Note that the three-dimensional model to be first projected on the frame is generated from the frame set by the three-dimensional model generation part 143, for example. For example, the three-dimensional model generation part 143 first generates a three-dimensional model by using the first frame and the second frame in the frame set, and projects the generated three-dimensional model onto the third frame, thereby specifying an unprojected pixel on which the three-dimensional model has not been projected among the pixels of the third frame.

For example, the frame set generation part 141 arranges a plurality of frames in a frame order in a frame set. For example, the frame set generation part 141 generates a frame set in the frame order in which the plurality of frames is arranged on the basis of a predetermined condition. In this case, for example, the specification part 142 projects an existing three-dimensional model (third three-dimensional model), which is an already-generated three-dimensional model including the first three-dimensional model, on at least one second frame, and specifies an unprojected pixel on which the existing three-dimensional model has not been projected on at least one second frame on which the existing three-dimensional model has been projected. The specification part 142 and the second three-dimensional model generation part 145 repeatedly execute the above processing in the frame order. The existing three-dimensional model includes the first three-dimensional model and a generated second three-dimensional model.

Note that the predetermined condition may be arbitrarily determined in advance. For example, the frame set generation part 141 calculates a positive direction of a reference axis on the basis of an optical axis direction in each of the cameras 301 when a plurality of frames is captured. That is, the frame set generation part 141 determines the frame order on the basis of the calculated positive direction of the reference axis, and generates a frame set in the determined frame order.

The optical axis direction is, for example, a direction orthogonal to a light incident surface of a sensor included in the camera 301. Alternatively, the optical axis direction is, for example, an optical axis direction of a lens included in the camera 301. The positive direction of the optical axis is, for example, a normal direction of the light incident surface of the sensor included in the camera 301. A negative direction of the optical axis is, for example, a direction in which light enters the camera 301.

There is one piece of data (optical axis data) indicating the optical axis direction of the camera for one frame. That is, the frame set generation part 141 generates a frame set including a frame selected from the plurality of frames on the basis of a plurality of pieces of optical axis data indicating the optical axis direction of the camera 301 at each time of capturing the plurality of frames.

For example, the frame set generation part 141 selects a representative frame that is one of the plurality of frames from the plurality of frames, and calculates the optical axis direction of the camera 301 that has captured the selected representative frame as the positive direction of the reference axis. Note that the number of representative frames may be one or two or more. In a case where the number of representative frames is two or more, the frame set generation part 141 may set an average value in the optical axis direction of each of the cameras 301 that have captured the selected two or more representative frames as a reference axis direction.

Further, for example, the frame set generation part 141 generates a frame set in a frame order in which frames are arranged in order of being captured at a position close to the subject in the reference axis direction. In other words, the frame set generation part 141 generates a frame set in which frames are arranged in an order in which the position of the camera 301 at each time of capturing a plurality of frames in the frame set is closer to the predetermined region. Specifically, in a case where the orientation of the predetermined region viewed from the camera 301, that is, the direction from the camera 301 toward the predetermined region is the positive direction of the reference axis, the frame set generation part 141 generates a frame set in which a plurality of frames is arranged in the order in which the position of the camera 301 at each time of capturing the plurality of frames in the frame set is closer to the predetermined region in the positive direction of the reference axis.

Note that the frame set generation part 141 may generate the frame set using all the frames included in the plurality of frames stored in the storage part 120, or may generate the frame set using some of the plurality of frames.

For example, the frame set generation part 141 determines whether or not each of the plurality of frames satisfies a first condition, and generates a frame set with frames that satisfy the first condition among the plurality of frames.

Note that the predetermined first condition may be arbitrarily determined in advance. For example, the frame set generation part 141 determines, as a predetermined first condition, that the angle formed between the positive direction of the reference axis and the optical axis direction of the camera 301 at the time of capturing the plurality of frames included in the frame set is equal to or less than a predetermined first angle. That is, when the angle formed between the reference axis direction and the optical axis direction of the camera 301 is equal to or less than the first angle, the frame set generation part 141 includes the frame captured by the camera 301 in the frame set. On the other hand, when the angle formed between the reference axis direction and the optical axis direction of the camera 301 is larger than the first angle, the frame set generation part 141 does not include the frame captured by the camera 301 in the frame set.

The integration part 148 is a processing part that integrates the three-dimensional models stored in the storage part 120. For example, the integration part 148 integrates the existing three-dimensional model and the new three-dimensional model stored in the storage part 120 to generate one three-dimensional model. The integration part 148 generates point cloud data of the three-dimensional model by integrating the existing three-dimensional model and the new three-dimensional model.

Referring again to FIG. 2, the mesh generation part 150 generates mesh data from the point cloud data of the three-dimensional model. The mesh generation part 150 generates mesh data including a plurality of polygons by connecting points constituting a point cloud with a straight line. The polygon is a two-dimensional virtual figure of a polygon such as a triangle or a quadrangle.

The texture mapping part 160 pastes an image representing a subject as a texture on the mesh data of the three-dimensional model generated by the mesh generation part 150 on the basis of the plurality of frames used to generate the point cloud data.

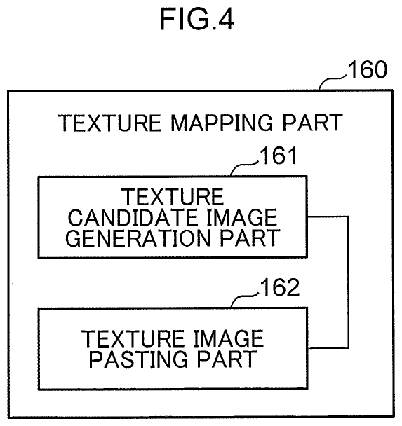

FIG. 4 is a block diagram illustrating a detailed configuration of the texture mapping part 160 included in the three-dimensional model generation device 100 according to the first embodiment.

The texture mapping part 160 includes a texture candidate image generation part 161 and a texture image pasting part 162.

The texture candidate image generation part 161 generates a plurality of texture candidate images to be pasted to a plurality of polygons constituting mesh data on the basis of an image in which distances between the plurality of polygons constituting the mesh data and the image are the shortest among images having pixel regions corresponding to the mesh data.

The texture candidate image generation part 161 generates a texture candidate image in which a region other than a region including the plurality of pixels corresponding to the point cloud in the image used to generate the point cloud data is subjected to the mask processing. Here, the region including the plurality of pixels is a region surrounded by edges detected by edge detection of the periphery of the plurality of pixels or a region in a plane estimated by plane estimation of the periphery of the plurality of pixels. The texture candidate image generation part 161 detects peripheral edges of the plurality of pixels corresponding to the point cloud in the image, and specifies a region surrounded by the detected edges as a non-mask region. In addition, the texture candidate image generation part 161 may estimate a plane around the plurality of pixels corresponding to the point cloud in the image, and specify a region in the estimated plane as a non-mask region. Then, the texture candidate image generation part 161 generates a texture candidate image obtained by performing the mask processing on a region other than the non-mask region in the image. The texture candidate image generation part 161 generates a plurality of texture candidate images from each of the plurality of images.

Further, the mask processing includes processing of making a region other than the region including the plurality of pixels corresponding to the point cloud in the image used to generate the point cloud data transparent. An a channel representing transparency is set to each pixel constituting an image. The a channel is a value representing the transparency of the pixel. For example, the a channel is set to 0.0≤α≤1.0, and becomes transparent when α=0.0, and becomes opaque when α=1.0. The texture candidate image generation part 161 sets the a channel of the pixel in the non-mask region to 1.0 (opaque), and sets the a channel of the pixel in the mask region other than the non-mask region to 0.0 (transparent).

Note that the mask processing in the present first embodiment is processing of making a region other than the region including the plurality of pixels corresponding to the point cloud in the image used to generate the point cloud data transparent, but the present disclosure is not particularly limited thereto. The mask processing may include processing of filling a region other than the region including the plurality of pixels in the image used to generate the point cloud data with a predetermined color. The predetermined color is, for example, black. The texture candidate image generation part 161 may set the color of pixels in the mask region other than the non-mask region to a predetermined color.

Further, the region including the plurality of pixels in the present first embodiment is a region surrounded by peripheral edges of the plurality of pixels or a region in the plane around the plurality of pixels, but the present disclosure is not particularly limited thereto. The region including the plurality of pixels may be a region surrounded by the plurality of pixels.

In addition, the texture candidate image generation part 161 may generate one texture candidate image by combining a plurality of texture candidate images.

The texture image pasting part 162 pastes the image of the region on the plurality of texture candidate images corresponding to the position of each of the plurality of polygons as a texture on each of the plurality of polygons.

The texture image pasting part 162 determines whether or not each of the plurality of polygons is visible from the position of the camera 301 of the texture candidate image. The texture image pasting part 162 pastes an image of the region on the texture candidate image corresponding to the position of the polygon determined to be visible from the position of the camera 301 to the polygon as a texture. Further, the texture image pasting part 162 determines whether or not a region on the texture candidate image corresponding to each position of the plurality of polygons has been subjected to the mask processing. The texture image pasting part 162 pastes the image of the region determined not to have been subjected to the mask processing on the polygon as a texture.

The texture image pasting part 162 outputs, for example, the texture-mapped three-dimensional model to the storage part 120. The storage part 120 stores the texture-mapped three-dimensional model input from the texture image pasting part 162.

Referring again to FIG. 2, the output part 170 is a processing part that outputs the three-dimensional model stored in the storage part 120. The output part 170 outputs, for example, the texture-mapped three-dimensional model stored in the storage part 120. The output part 170 includes, for example, an antenna, a wireless communication circuit, a connector, and the like for communicably connecting to a display device such as a display, not illustrated, in a wired or wireless manner. The output part 170 outputs the texture-mapped three-dimensional model to the display device to display the three-dimensional model on the display device.

### [Processing Procedure of Three-Dimensional Model Generation Device]

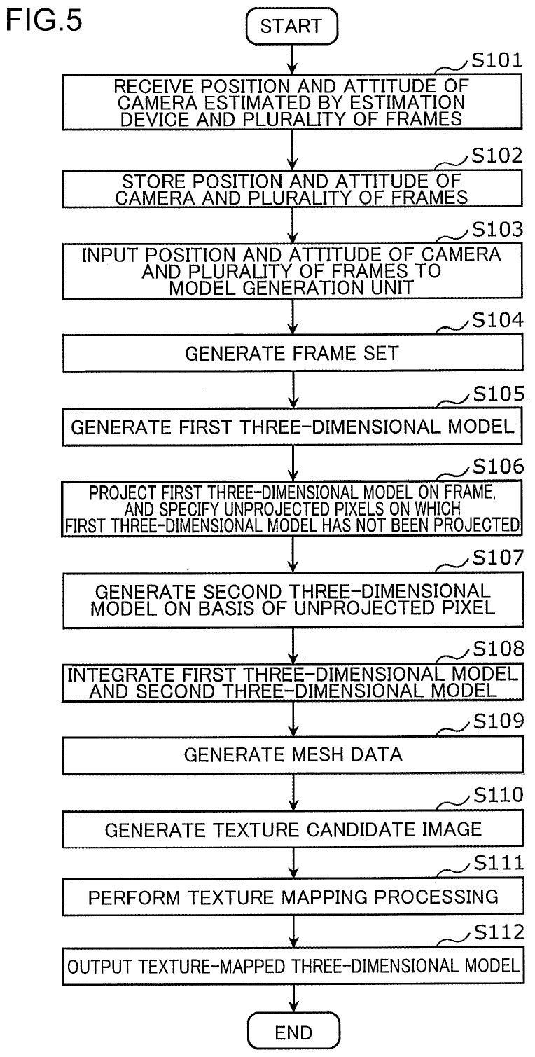

Next, a processing procedure of three-dimensional model generation executed by the three-dimensional model generation device 100 will be described in detail with reference to FIGS. 5 to 23.

### <Overview>

FIG. 5 is a flowchart illustrating processing executed by the three-dimensional model generation device 100 according to the first embodiment.

First, the reception part 110 receives information indicating the position and attitude of the camera 301 estimated by the estimation device 200, camera parameters, and a plurality of frames (imaging frames) (step S101). The reception part 110 outputs the received data to the storage part 120.

Next, the storage part 120 stores the information indicating the position and attitude of the camera 301, the camera parameters, and the plurality of frames (imaging frames) received by the reception part 110 in step S101 (step S102).

Next, the acquisition part 130 inputs the information indicating the position and attitude of the camera 301, the camera parameters, and the plurality of frames (imaging frames) stored in the storage part 120 to the model generation part 140 (step S103).

Next, the frame set generation part 141 generates a frame set including a plurality of frames in which the frame order is determined from a plurality of pieces of data indicating the position and attitude of each camera 301, the camera parameters, and the plurality of frames (imaging frames) at the time of capturing a plurality of frames (imaging frames) (step S104).

Next, the first three-dimensional model generation part 144 generates a three-dimensional model (first three-dimensional model) from the frame set (step S105). For example, the first three-dimensional model generation part 144 generates the first three-dimensional model using any two frames (first frames) in the frame set.

Next, the specification part 142 projects the first three-dimensional model generated in step S105 onto a frame (second frame) (step S106). Specifically, the specification part 142 projects the first three-dimensional model onto at least one second frame included in the frame set excluding the first frame.

Next, the second three-dimensional model generation part 145 generates a three-dimensional model (second three-dimensional model) on the basis of unprojected pixels on which the first three-dimensional model has not been projected in step S106 in the second frame (step S107).

Next, the integration part 148 integrates the first three-dimensional model and the second three-dimensional model (step S108). The integration part 148 outputs the point cloud data of the integrated three-dimensional model to the mesh generation part 150.

Next, the mesh generation part 150 generates mesh data from the point cloud data of the three-dimensional model (step S109).

Next, the texture candidate image generation part 161 generates a plurality of texture candidate images to be pasted to the plurality of polygons constituting the mesh data on the basis of an image in which distances between the plurality of polygons constituting the mesh data and the image are the shortest among images having pixel regions corresponding to the mesh data (step S110).

Next, the texture image pasting part 162 executes texture mapping processing of pasting an image of a region on the plurality of texture candidate images corresponding to respective positions of the plurality of polygons as a texture on each of the plurality of polygons (step S111).

Next, the output part 170 outputs the texture-mapped three-dimensional model (step S112).

### <Frame Order Determination Processing>

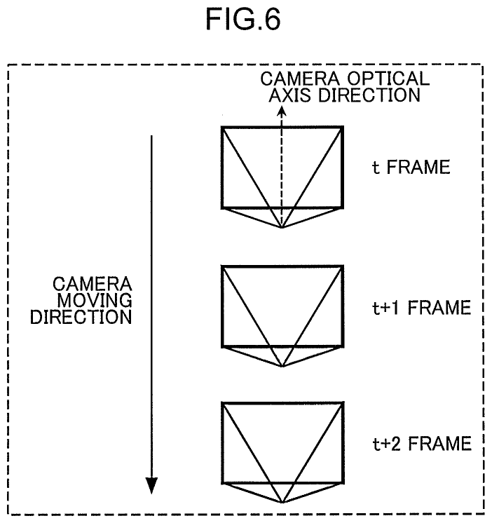

Next, the generation processing of the frame set (more specifically, frame order determination processing) executed by the frame set generation part 141 in step S104 of FIG. 5 will be described with reference to FIGS. 6 to 13.

The frame set generation part 141 may generate a frame set using all the frames included in the storage part 120, or may generate a frame set by selecting at least three frames among all the frames.

In addition, the frame set may be in the frame order in which the position and attitude of the camera 301 move in the negative direction of the optical axis direction (in other words, the imaging direction) of the camera 301.

In addition, the model generation part 140 (more specifically, the frame set generation part 141) may generate a frame set by thinning out frames from the plurality of frames stored in the storage part 120.

For example, in a case where the acquisition part 130 acquires the plurality of frames from the storage part 120 in a random frame order, the frame set generation part 141 generates a frame set in which the frame order of the frame set is rearranged in an order in which the position and attitude of the camera 301 that has captured the plurality of frames are smaller in the negative direction of the camera optical axis direction, that is, in the order in which the position of the camera 301 when the frame is captured is closer to the subject.

Note that the frame set generation part 141 may individually add specification information such as an index number indicating the frame order to each frame of the frame set, or may collectively add the specific information to the frame set.

Note that a t frame, a t+1 frame, a t+2 frame, a t+3 frame, a t+4 frame, and a t+5 frame to be described below are frames captured in this order in time series by the camera 301. Further, in FIGS. 6 to 13, description will be given on the assumption that a target object to be a subject exists in the camera optical axis direction in each drawing. Further, in FIGS. 6 to 13, the camera optical axis direction in each drawing coincides with the reference axis direction.

### First Example

FIG. 6 is a diagram for describing a first example of a capturing order of the camera 301.

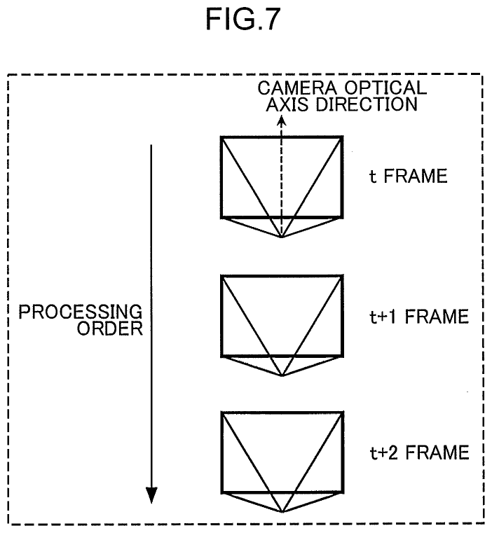

FIG. 7 is a diagram for describing a first example of a frame order determined by the three-dimensional model generation device 100 with respect to the capturing order of the camera 301.

The first example is an example in which the camera 301 captures a subject while being separated from the subject. In this case, the model generation part 140 (more specifically, the frame set generation part 141) generates a frame set in which the frame order is set in accordance with a camera moving direction, that is, in an order in which the subject is captured as in the processing order in FIG. 7.

As described above, in a case where a plurality of frames is captured by the camera 301 so that the position of the camera 301 moves away from the subject, the frame set generation part 141 generates a frame set in the capturing order, and thereby can generate a frame set in which frames are arranged in the order of the frames generated in the order in which the camera 301 is closer to the subject.

### Second Example

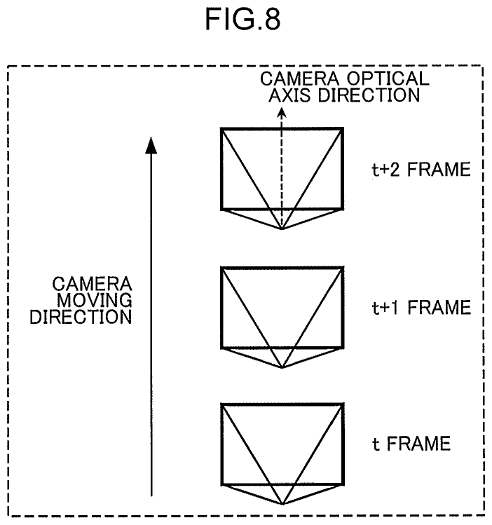

FIG. 8 is a diagram for describing a second example of the capturing order of the camera 301.

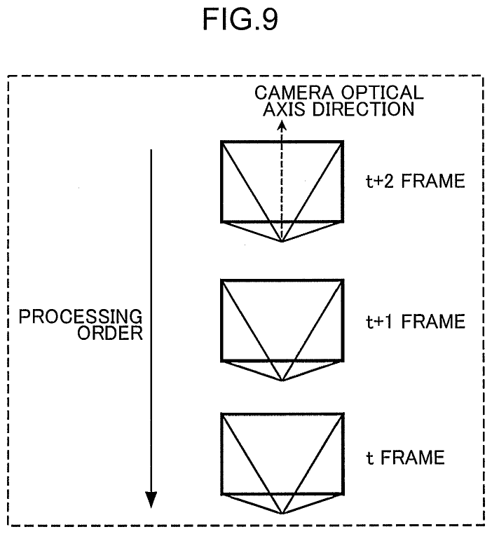

FIG. 9 is a diagram for describing a second example of the frame order determined by the three-dimensional model generation device 100 with respect to the capturing order of the camera 301.

The second example is an example in which the camera 301 captures an image of a subject while approaching the subject. In this case, as in the processing order of FIG. 9, the frame set generation part 141 generates a frame set in which the frame order is set in an order opposite to the camera moving direction, that is, in an order opposite to the order in which the subject is captured.

As described above, in a case where a plurality of frames with the position of the camera 301 approaching the subject is captured by the camera 301, the frame set generation part 141 generates a frame set in which the frames are rearranged in a reverse order of the capturing, and thereby can generate a frame set in which the frames are arranged in the order of the frames generated in the order in which the camera 301 is closer to the subject.

As described above in the first example and the second example, in a case where a change in position when the frame is captured by the camera 301 is constant with respect to the subject, and time information indicating the time when the frame is captured is added to the frame, the frame set generation part 141 may generate a frame set in which the frames are rearranged on the basis of the time information.

### Third Example

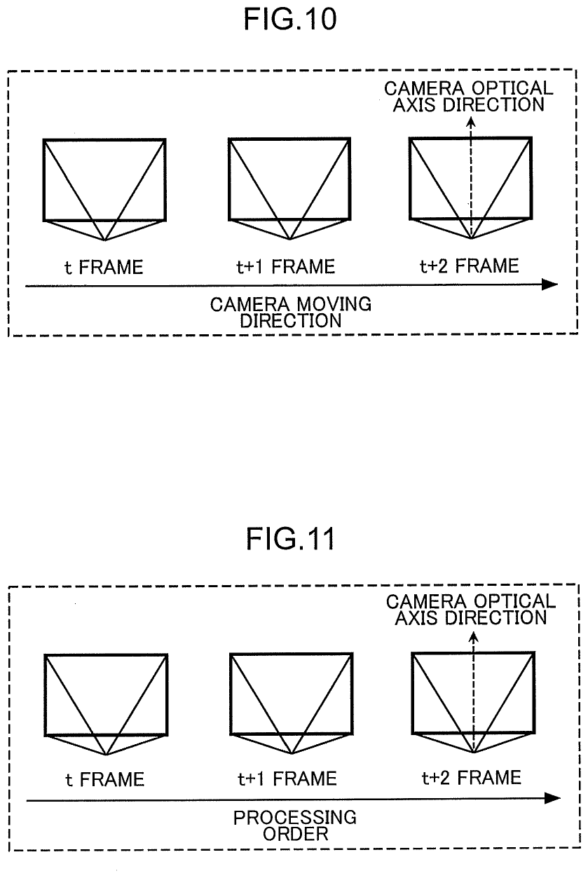

FIG. 10 is a diagram for describing a third example of the capturing order of the camera 301.

FIG. 11 is a diagram for describing a third example of the frame order determined by the three-dimensional model generation device 100 with respect to the capturing order of the camera 301.

The third example is an example in which the camera 301 captures the subject while moving without changing the distance to the subject. In this case, the frame set generation part 141 may generate a frame set by rearranging the frame order in any order. FIG. 11 illustrates processing of generating a frame set in which the frame order is set in accordance with the camera moving direction, that is, in the order in which the subject is captured.

As described above, in a case where the multi-viewpoint video is captured so that the position of the camera 301 is parallel to the subject, that is, the distance between the subject and the camera 301 does not change, the frame set generation part 141 generates the frame set from the plurality of frames regardless of the capturing order.

### Fourth Example

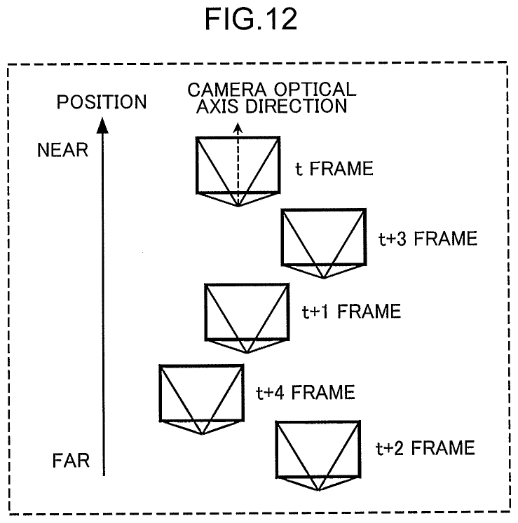

FIG. 12 is a diagram for describing a fourth example of the capturing order of the camera 301.

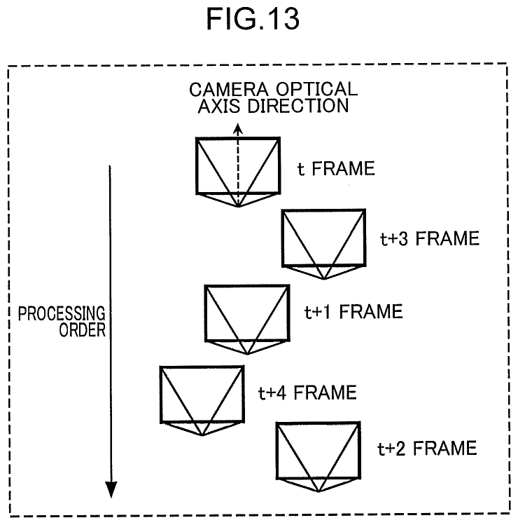

FIG. 13 is a diagram for describing a fourth example of the frame order determined by the three-dimensional model generation device 100 with respect to the capturing order of the camera 301.

The fourth example is an example in which the camera 301 moves while randomly changing the distance to the subject and captures the subject. In this case, as in the processing order illustrated in FIG. 13, the frame set generation part 141 generates a frame set by rearranging the frame order in order from a frame captured at a position close to the subject, in other words, in order from a frame located on a positive direction side in the camera optical axis direction. In the example illustrated in FIG. 13, the frame set generation part 141 generates frame sets in the order of the t frame, the t+3 frame, the t+1 frame, the t+4 frame, and the t+2 frame.

By performing such processing, the frame set generation part 141 can generate a frame set in which the frame order is rearranged in the order in which the position of the camera 301 is closer to the subject regardless of the order in which the frames are captured.

### <Frame Specifying Processing>

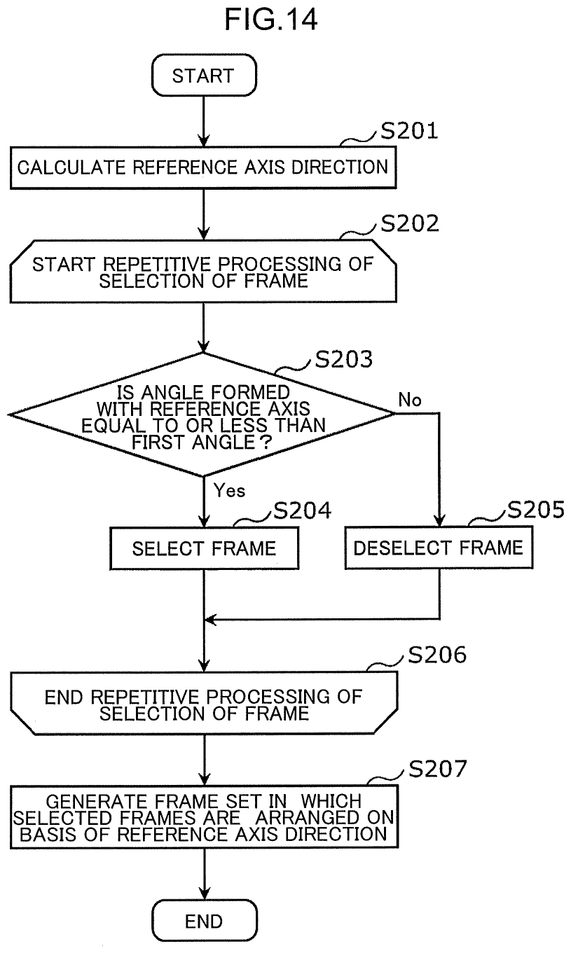

Subsequently, a processing procedure of the frame specifying processing executed by the frame set generation part 141 will be described with reference to FIG. 14.

As described above, the frame set generation part 141 generates a frame set in which the plurality of frames is rearranged so that the frames are in a frame order of capturing by the camera 301 at a position close to the subject, that is, in a frame order in which the position of the camera 301 at each time of capturing the plurality of frames is closer to the predetermined region.

Here, for example, when generating the three-dimensional model, the three-dimensional model generation part 143 may generate the three-dimensional model without using all the frames among the plurality of imaging frames stored in the storage part 120 (in other words, all imaging frames captured by the camera 301). That is, the model generation part 140 (more specifically, the frame set generation part 141) may generate a frame set obtained by thinning out some frames from the plurality of frames (imaging frames). In other words, the frame set generation part 141 may generate a frame set by specifying some frames from all the frames captured by the camera 301 (in other words, select).

FIG. 14 is a flowchart illustrating an example of frame set generation processing executed by the three-dimensional model generation device 100 according to the first embodiment.

First, the frame set generation part 141 calculates a reference axis direction (more specifically, the positive direction of the reference axis) from a plurality of frames (step S201).

In step S201, for example, the frame set generation part 141 calculates the optical axis direction of the camera 301 at each time of capturing each frame on the basis of the camera parameters, and calculates the reference axis direction on the basis of each calculated optical axis direction. For example, the frame set generation part 141 calculates an average position of respective positions of the camera 301 when each frame is captured. Moreover, the frame set generation part 141 calculates, for example, an average value of angles (average angle) formed by the optical axis direction of the camera 301 when each frame is captured with a predetermined axis that passes through the calculated average position and is arbitrarily determined in advance. For example, the frame set generation part 141 calculates, as the reference axis direction, a direction of an axis that passes through the calculated average position and is inclined by the calculated average angle with respect to a predetermined axis.

Alternatively, the frame set generation part 141 calculates the optical axis direction of the camera 301 at each time when each frame is captured, and calculates the reference axis direction by using a least squares method for the plurality of optical axis directions. At this time, the frame set generation part 141 may exclude the optical axis direction in which the error is larger than a predetermined threshold.

Alternatively, in step S201, for example, the frame set generation part 141 determines a representative frame serving as a representative from the plurality of frames, and sets the optical axis direction of the camera 301 that has captured the determined representative frame as the reference axis direction.

A method for determining the representative frame may be any method. For example, the frame set generation part 141 sets, as the representative frame, a frame captured by the camera 301 at a position closest to the subject among the cameras 301 that have captured the plurality of frames. Alternatively, the frame set generation part 141 sets, as the representative frame, a frame captured by the camera 301 at a position where the distance to the subject is intermediate among the cameras 301 that have captured the plurality of frames.

Next, the frame set generation part 141 starts repetitive processing of frame selection (step S202). Specifically, the frame set generation part 141 repeatedly executes processing of steps S203 to S205 for each of the plurality of frames stored in the storage part 120.

The frame set generation part 141 determines whether or not an angle formed between the reference axis (more specifically, the positive direction of the reference axis) calculated in step S201 and the optical axis direction of the camera 301 that has captured the frame is equal to or less than the first angle (step S203).

When it is determined that the angle formed between the reference axis calculated in step S201 and the optical axis direction of the camera 301 that has captured the frame is not equal to or less than the first angle (No in step S203), the frame set generation part 141 deselects the frame (step S205). That is, in a case of No in step S203, the frame set generation part 141 does not select the frame and does not add the frame to the frame set to be generated. Note that “to deselect” indicates that the frame is not used in the processing to be executed by the frame set generation part 141 in step S207 thereafter, and for example, it is not necessary to delete the frame from the storage part 120.

On the other hand, when it is determined that the angle formed between the reference axis calculated in step S201 and the optical axis direction of the camera 301 that has captured the frame is equal to or less than the first angle (Yes in step S203), the frame set generation part 141 selects the frame (step S204). Here, “to select” indicates that the frame is used in the processing to be executed by the frame set generation part 141 in step S207 thereafter.

The frame set generation part 141 executes repetitive processing of steps S203 to S205, that is, repetitive processing of selecting or deselecting a frame for each of the plurality of frames, and then ends the repetitive processing (step S206).

Next, the frame set generation part 141 generates a frame set by rearranging the frames selected in step S204 so that the frames are in a frame order of capturing at a position close to the subject along the reference axis calculated in step S201, that is, in a frame order in which the position of the camera 301 at each time of capturing the plurality of frames is closer to the predetermined region (step S207). In step S207, for example, the frame set generation part 141 sorts and associates serial numbers in the order of the plurality of rearranged frames.

Note that the threshold for the first angle only needs to be stored in advance in the storage part 120, for example. Further, the first angle may be arbitrarily set, and a value thereof is not particularly limited. In addition, the frame set generation part 141 may select the representative frame on the basis of, for example, the position of the camera 301 instead of the angle formed with the reference axis.

In addition, the frame set generation part 141 may store the generated frame set in the storage part 120, or may output the frame set to the three-dimensional model generation part 143 that generates a new three-dimensional model on the basis of the frame set thereafter.

Further, in step S203, it has been described that the angle is equal to or less than the first angle, but it is not described in a strict sense. For example, “equal to or less than the first angle” may mean that the angle is smaller than the first angle.

### <Three-Dimensional Model Generation Processing>

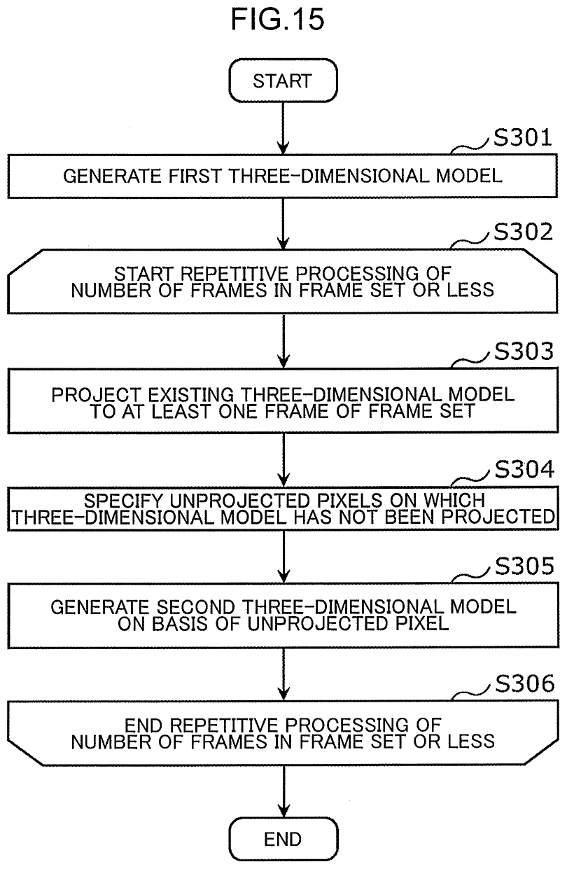

Next, three-dimensional model generation processing executed by the three-dimensional model generation device 100 will be described with reference to FIGS. 15 to 18.

FIG. 15 is a flowchart illustrating three-dimensional model generation processing executed by the three-dimensional model generation device 100 according to the first embodiment.

First, the first three-dimensional model generation part 144 generates a three-dimensional model (first three-dimensional model) using a plurality of frames (first frames) in a frame set (step S301).

Next, the model generation part 140 starts repetitive processing of the number of frames included in the frame set or less (step S302). Specifically, the model generation part 140 repeatedly executes processing of steps S302 to S306 for each of the plurality of frames included in the frame set and excluding the frame used in step S301.

Next, the specification part 142 projects the already generated three-dimensional model (existing three-dimensional model, that is, the third three-dimensional model) onto at least one frame (second frame) in the frame set (step S303). In step S303, the specification part 142 projects the existing three-dimensional model onto the frame of the frame set in the frame order determined by the frame set generation part 141. Initially, the existing three-dimensional model is only the first three-dimensional model generated in step S301, but by repeating processing in steps S303 to S305, a new three-dimensional model (second three-dimensional model) generated in step S305 described later is repeatedly added to the already-generated three-dimensional model.

Here, a method for projecting the existing three-dimensional model on the second frame will be described.

In a case where the coordinates of each point of the existing three-dimensional model on the three-dimensional space are (X, Y, Z), the focal distance of the camera parameter is f, the pixel to be projected is (u, v), and the frame is a pinhole model, u is represented by (f/Z+f)*X, and v is represented by (f/Z+f)*Y.

Next, the specification part 142 specifies an unprojected pixel on which the three-dimensional model (specifically, the three-dimensional point constituting the three-dimensional model) has not been projected in the second frame on which the three-dimensional model has been projected (step S304).

Next, the second three-dimensional model generation part 145 newly generates a new three-dimensional model (second three-dimensional model) on the basis of the unprojected pixels specified in step S304 (step S305). That is, the second three-dimensional model generation part 145 generates the second three-dimensional model including points that do not exist in the existing three-dimensional model.

Next, the model generation part 140 ends the repetitive processing of the number of frames in the frame set or less (step S306). That is, in the second and subsequent rounds of processing in the loop processing of steps S303 to S305, in step S303, the second three-dimensional model generated in step S305 before that is included in the existing three-dimensional model.

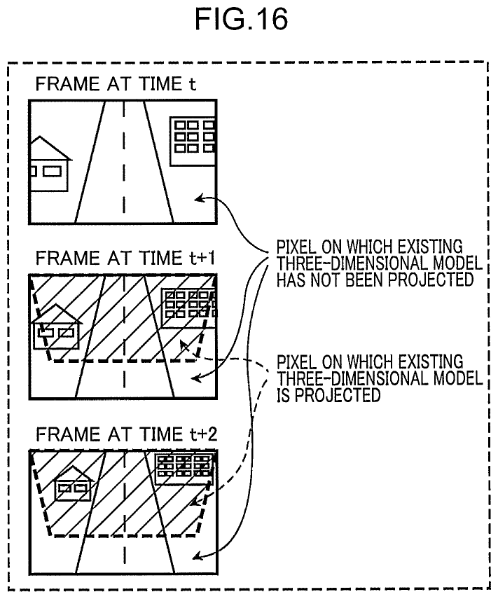

FIG. 16 is a diagram for describing a processing position of a frame in generation processing executed by the model generation part 140 included in the three-dimensional model generation device 100 according to the first embodiment.

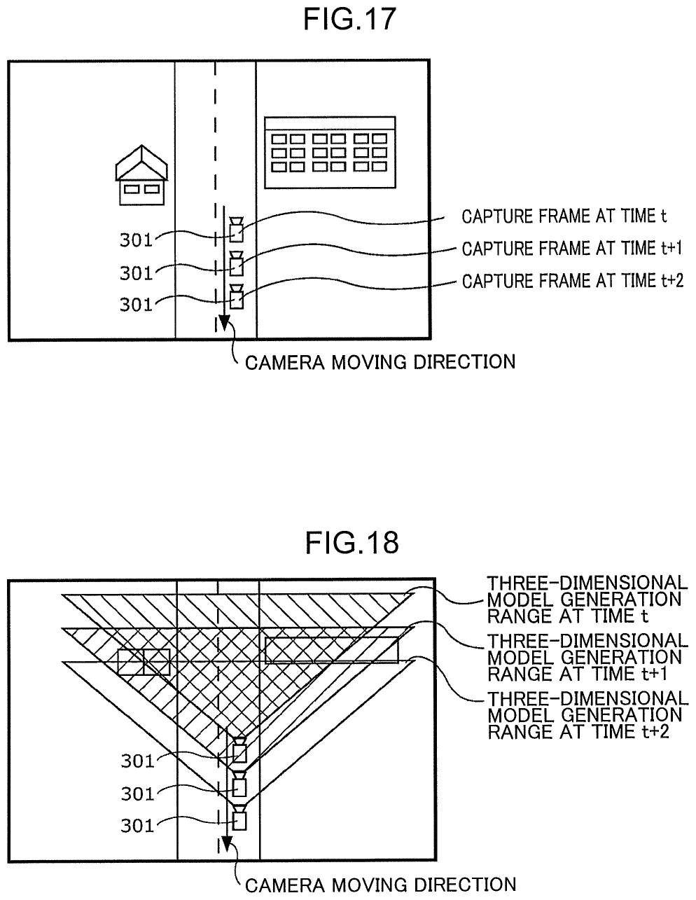

FIG. 17 is a diagram for describing a change in a capturing position by the camera 301.

FIG. 18 is a diagram for describing a change in a capturing range by the camera 301.

Note that a frame at time t, a frame at time t+1, and a frame at time t+2 illustrated in FIG. 16 indicate frames captured by the camera 301 illustrated in each of FIGS. 17 and 18. Further, FIGS. 17 and 18 are diagrams illustrating the same scene. FIG. 17 is a perspective view, and FIG. 18 is a top view. In FIG. 18, the three-dimensional model generation range (that is, the capturing range) at time t and time t+1 is hatched.

For example, it is assumed that the existing three-dimensional model has not been projected at all locations for the frame at time t illustrated in FIG. 16. In this case, the second three-dimensional model generation part 145 generates the second three-dimensional model for all the pixels of the frame at time t.

Further, for example, it is assumed that the existing three-dimensional model is projected at some portions indicated by hatching for the frame at time t+1 illustrated in FIG. 16. Specifically, it is assumed that the hatched portion in the frame at time t+1 in FIG. 16 is the pixel position where the second three-dimensional model generated by the frame at time t in FIG. 16 is projected. In this case, the second three-dimensional model generation part 145 generates the second three-dimensional model for the pixels at the non-hatched portion illustrated in the frame at time t+1 in FIG. 16.

Further, for example, it is assumed that the existing three-dimensional model is projected at some portions indicated by hatching for the frame at time t+2 illustrated in FIG. 16. Specifically, it is assumed that the hatched portion in the frame at time t+2 in FIG. 16 is a pixel position where the second three-dimensional model generated by the frame at time t in FIG. 16 and the second three-dimensional model generated by the frame at time t+1 in FIG. 16 are projected. In this case, the second three-dimensional model generation part 145 generates the second three-dimensional model for the pixel (that is, the unprojected pixel) at the position not hatched illustrated in the frame at time t+2 in FIG. 16.

As described above, the second three-dimensional model generation part 145 generates the second three-dimensional model in frame order in the frame set generated by the frame set generation part 141.

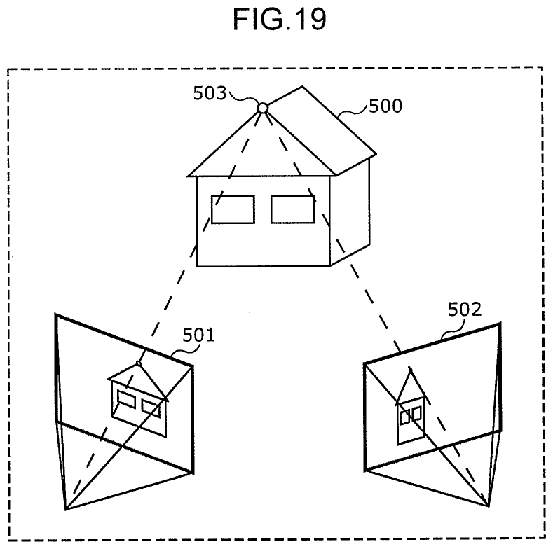

Next, a method for generating a three-dimensional model will be described with reference to FIG. 19.

In a case where the three-dimensional model generation part 143 generates the first three-dimensional model, for example, an existing three-dimensional point is generated using two frames.

FIG. 19 is a diagram for describing a processing procedure in which the three-dimensional model generation part 143 generates a three-dimensional model.

As illustrated in FIG. 19, for example, the first three-dimensional model generation part 144 generates the first three-dimensional model of the subject 500 using two frames of a reference frame 501 and a visible frame 502.

The reference frame 501 and the visible frame 502 are not particularly limited as long as they each include a common place (for example, feature point 503 illustrated in FIG. 19) in the subject 500 and the subject 500.

For example, the first three-dimensional model generation part 144 generates the first three-dimensional model by using the first frame of the frame set as the reference frame 501 and the second frame of the frame set as the visible frame 502. For example, the first three-dimensional model generation part 144 calculates normalized cross correlation (NCC) between small regions as N (I, J) by a combination of the reference frame 501 and the visible frame 502 as expressed in the following Expression (1), and generates matching information indicating a result of performing matching between frames. Further, the first three-dimensional model generation part 144 generates a three-dimensional model by performing triangulation from information indicating the position and attitude of the camera 301 at each time of capturing each of the reference frame 501 and the visible frame 502 and matching information between frames.

$$[ Math . 1 ]$$

$$N ( I , J ) = \frac{\sum ( {I}_{x y} − \overline{{I}_{x y}} ) \cdot ( {J}_{x y} − \overline{{J}_{x y}} )}{\sqrt{{( {I}_{x y} − \overline{{I}_{x y}} )}^{2}} \sqrt{{( J − \overline{{J}_{x y}} )}^{2}}} \qquad ( 1 )$$

Note that Ixy and Jxy are pixel values in the small regions of the frame I and the frame J. Further, an Ixy bar (a bar above Ixy) and a Jxy bar (a bar above Jxy) are average values of pixel values in the small regions of the frame I and the frame J, respectively.

Also in a case where the second three-dimensional model generation part 145 generates the second three-dimensional model, the procedure is similar to that in a case where the first three-dimensional model generation part 144 generates the first three-dimensional model. Specifically, for example, when the first three-dimensional model generation part 144 generates the first three-dimensional model by using the first frame of the frame set as the reference frame 501 and using the second frame of the frame set as the visible frame 502, the second three-dimensional model generation part 145 projects the first three-dimensional model onto the visible frame by newly using the third frame of the frame set as a visible frame.

For example, as illustrated in the above Expression (1), the second three-dimensional model generation part 145 calculates NCC between small regions as N (I, J) by a combination of the reference frame 501 (for example, the first frame of the frame set) and pixels on which the first three-dimensional model has not been projected in a newly used visible frame, and generates matching information indicating a matching result obtained by performing matching between frames. Further, the second three-dimensional model generation part 145 generates a second three-dimensional model by performing triangulation from information indicating the position and attitude of the camera 301 at each time of capturing the reference frame 501 and the newly used visible frame and matching information between frames.

### <Texture Candidate Image Generation Processing>

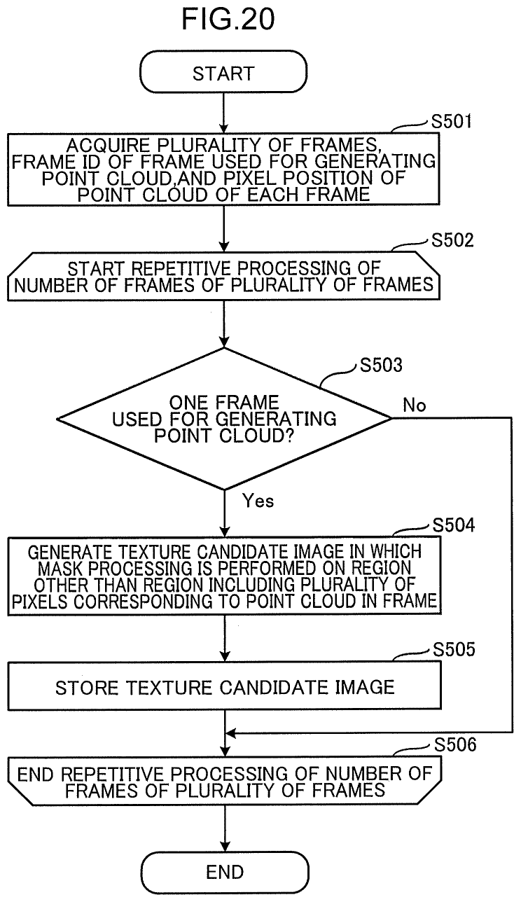

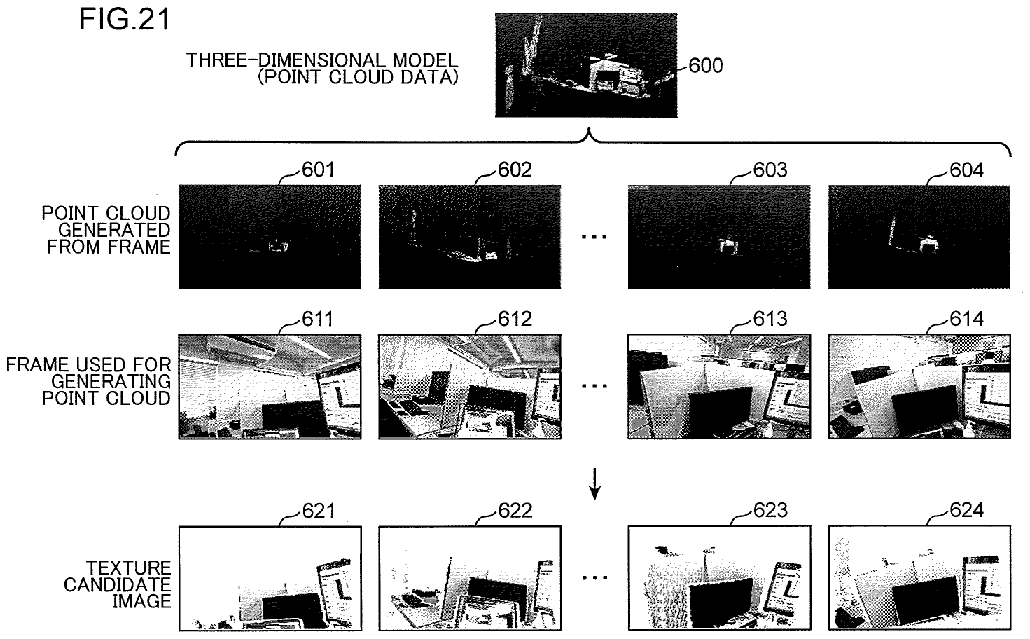

Next, a processing procedure of texture candidate image generation processing executed by the texture candidate image generation part 161 will be described with reference to FIGS. 20 and 21.

FIG. 20 is a flowchart illustrating texture candidate image generation processing executed by the three-dimensional model generation device 100 according to the first embodiment.

First, the texture candidate image generation part 161 acquires a plurality of frames (images), a frame ID of a frame used to generate the point cloud, and a pixel position of the point cloud of each frame from the storage part 120 (step S501). The plurality of frames acquired by the texture candidate image generation part 161 includes a frame used to generate the point cloud and a frame not used to generate the point cloud. The storage part 120 stores the frame ID of the frame used to generate the point cloud. Further, the storage part 120 stores the pixel positions of the point cloud of the frame in which the point cloud is generated.

Next, the texture candidate image generation part 161 starts repetitive processing of the number of frames of the acquired plurality of frames (step S502). Specifically, the texture candidate image generation part 161 repeatedly executes processing of steps S502 to S506 for each of the acquired plurality of frames.

First, the texture candidate image generation part 161 selects one frame among the acquired plurality of frames, and executes processing of steps S503 to S505. After executing the processing of steps S503 to S505, the texture candidate image generation part 161 selects one unselected frame among the acquired plurality of frames. The texture candidate image generation part 161 executes the processing of steps S502 to S506 until there is no frame to be selected.

Next, the texture candidate image generation part 161 determines whether or not one frame among the plurality of frames is a frame used for generating the point cloud (step S503). When the frame ID of one frame among the plurality of frames matches the frame ID of the frame used to generate the point cloud, the texture candidate image generation part 161 determines that one frame among the plurality of frames is a frame used to generate the point cloud. Further, when the frame ID of one of the plurality of frames is different from the frame ID of the frame used to generate the point cloud, the texture candidate image generation part 161 determines that one of the plurality of frames is not the frame used to generate the point cloud.

Here, when it is determined that one frame among the plurality of frames is not a frame used for generating the point cloud (No in step S503), the processing proceeds to step S506.

On the other hand, when it is determined that one frame among the plurality of frames is a frame used for generating the point cloud (Yes in step S503), the texture candidate image generation part 161 generates a texture candidate image in which a region other than the region including the plurality of pixels corresponding to the point cloud in the frame is subjected to the mask processing (step S504).

Next, the texture candidate image generation part 161 stores the generated texture candidate image in the storage part 120 (step S505).

Next, the texture candidate image generation part 161 ends the repetitive processing of the number of frames of the plurality of frames (step S506). That is, a plurality of texture candidate images is generated from all the frames used to generate the point cloud by the loop processing of steps S503 to S505. After the processing of steps S503 to S505 is performed on all the plurality of frames, the texture candidate image generation processing ends.

FIG. 21 is a diagram for describing texture candidate image generation processing executed by the texture candidate image generation part 161 included in the three-dimensional model generation device 100 according to the first embodiment.

A three-dimensional model 600 illustrated in FIG. 21 is a point cloud indicating a shape of a subject restored in a virtual three-dimensional space. The model generation part 140 generates a three-dimensional model (point cloud data) 600.

Frames 611 to 614 are frames used to generate the point cloud. The frames 611 to 614 are arranged in ascending order of distance from the camera 301 to the subject. The point clouds 601 to 604 are point clouds (three-dimensional models) generated from the frames 611 to 614. For example, the three-dimensional model generation part 143 generates the point cloud 601 from the frame 611. The specification part 142 projects the point cloud 601 onto the frame 612, and specifies an unprojected pixel that is a pixel on which the point cloud 601 has not been projected among the frames 612 on which the point cloud 601 is projected. The three-dimensional model generation part 143 newly generates the point cloud 602 for the unprojected pixel specified by the specification part 142.

Texture candidate images 621 to 624 are images that are candidates for a plurality of texture images to be pasted to a plurality of polygons constituting mesh data of the three-dimensional model 600. The texture candidate image generation part 161 generates the texture candidate images 621 to 624 in which a region other than the region including the plurality of pixels corresponding to the point cloud in the frames 611 to 614 used to generate the point cloud is subjected to the mask processing. For example, the texture candidate image generation part 161 detects peripheral edges of the plurality of pixels corresponding to the point cloud in the frame 611 used to generate the point cloud, and specifies a region surrounded by the detected edges as a non-mask region. Then, the texture candidate image generation part 161 generates the texture candidate image 621 obtained by performing mask processing on a region other than the non-mask region in the frame 611. The texture candidate image generation part 161 generates the texture candidate images 621 to 624 from the frames 611 to 614 used to generate the point cloud, respectively.

### <Texture Image Pasting Processing>

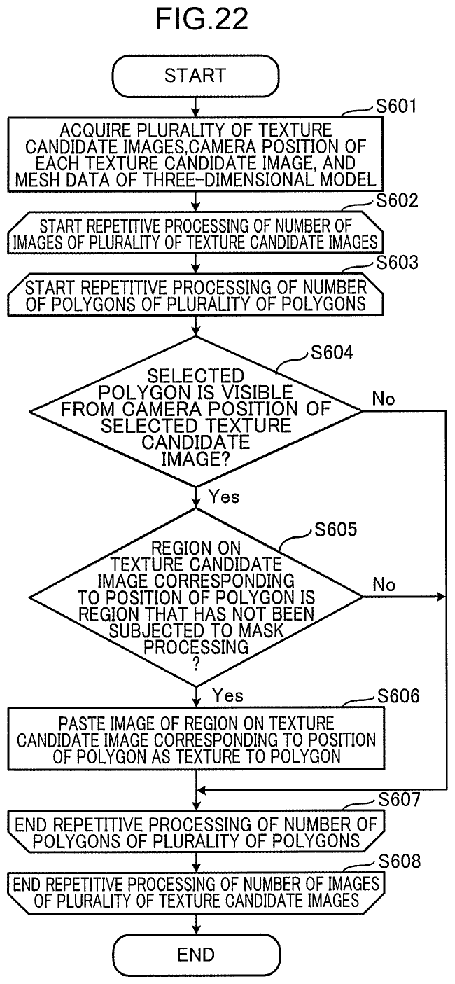

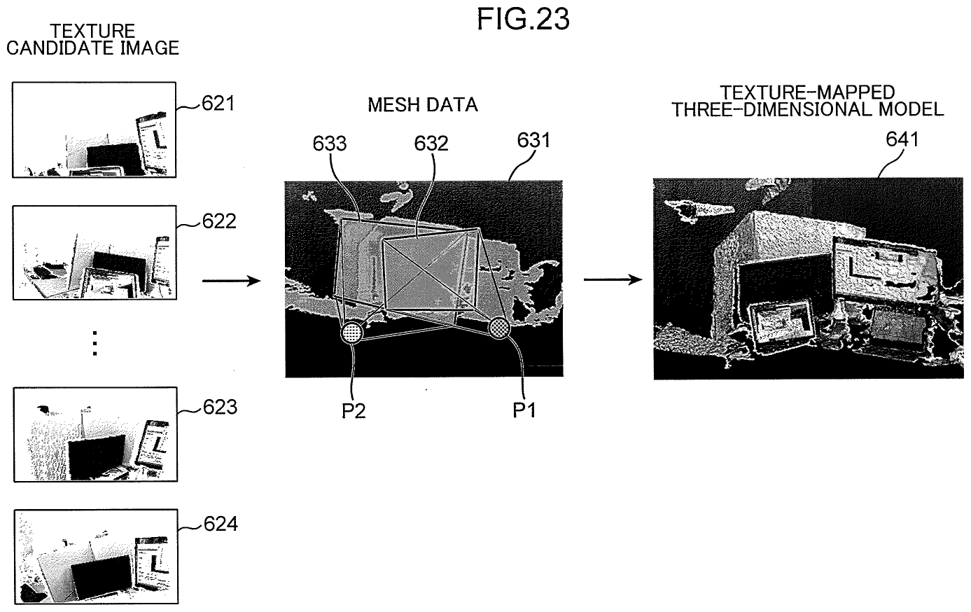

Next, a processing procedure of the texture image pasting processing executed by the texture image pasting part 162 will be described with reference to FIGS. 22 and 23.

FIG. 22 is a flowchart illustrating texture image pasting processing executed by the three-dimensional model generation device 100 according to the first embodiment.

First, the texture image pasting part 162 acquires the plurality of texture candidate images, the position of the camera 301 of each texture candidate image, and the mesh data of the three-dimensional model from the storage part 120 (step S601). The storage part 120 stores a plurality of texture candidate images, a position of the camera 301 of each texture candidate image, and mesh data of a three-dimensional model. The position of the camera 301 of the texture candidate image represents the position of the camera 301 that has captured the frame used to generate the texture candidate image.

Next, the texture image pasting part 162 starts repetitive processing of the number of images of the acquired plurality of texture candidate images (step S602). Specifically, the texture image pasting part 162 repeatedly executes processing of steps S602 to S608 for each of the plurality of acquired texture candidate images.

First, the texture image pasting part 162 selects one texture candidate image among the plurality of acquired texture candidate images, and executes processing of steps S603 to S607. After executing the processing of steps S603 to S607, the texture image pasting part 162 selects one unselected texture candidate image among the plurality of acquired texture candidate images. The texture image pasting part 162 executes the processing of steps S602 to S608 until there is no texture candidate image to be selected.

Next, the texture image pasting part 162 starts repetitive processing of the number of polygons of a plurality of polygons constituting the acquired mesh data (step S603). Specifically, the texture image pasting part 162 repeatedly executes the processing of steps S603 to S607 for each of the plurality of polygons constituting the acquired mesh data.

First, the texture image pasting part 162 selects one polygon among the plurality of polygons and executes the processing of steps S604 to S606. After executing the processing of steps S604 to S606, the texture image pasting part 162 selects one unselected polygon among the plurality of polygons. The texture image pasting part 162 executes the processing of steps S603 to S607 until there is no polygon to be selected.

Next, the texture image pasting part 162 determines whether or not the selected polygon is visible from the position of the camera 301 of the selected texture candidate image (step S604). That is, the texture image pasting part 162 determines whether or not the selected polygon is included in the capturing range from the position of the camera 301 of the selected texture candidate image.

Here, when it is determined that the selected polygon is not visible from the position of the camera 301 of the selected texture candidate image (No in step S604), the processing proceeds to step S607.

On the other hand, when it is determined that the selected polygon is visible from the position of the camera 301 of the selected texture candidate image (Yes in step S604), the texture image pasting part 162 determines whether or not a region on the texture candidate image corresponding to the position of the polygon is a region that has not been subjected to the mask processing (step S605).

At this time, the texture image pasting part 162 refers to the a channel of the region on the texture candidate image corresponding to the position of the polygon. If the a channel is 0, the texture image pasting part 162 determines that the region on the texture candidate image corresponding to the position of the polygon is a region that has been subjected to the mask processing. Further, when the a channel is 1, the texture image pasting part 162 determines that the region on the texture candidate image corresponding to the position of the polygon is a region that has not been subjected to the mask processing.

Note that, if the a channels of all the pixels constituting the region on the texture candidate image corresponding to the position of the polygon are 1, the texture image pasting part 162 may determine that the region on the texture candidate image corresponding to the position of the polygon is a region that has not been subjected to the mask processing. Further, if the number of pixels having the a channel of 1 is larger than the number of pixels having the a channel of 0 among the plurality of pixels constituting the region on the texture candidate image corresponding to the position of the polygon, the texture image pasting part 162 may determine that the region on the texture candidate image corresponding to the position of the polygon is a region that has not been subjected to the mask processing.

Here, when it is determined that the region on the texture candidate image corresponding to the position of the polygon is a region that has been subjected to the mask processing (No in step S605), the processing proceeds to step S607.

On the other hand, when it is determined that the region on the texture candidate image corresponding to the position of the polygon is a region that has not been subjected to the mask processing (Yes in step S605), the texture image pasting part 162 pastes an image of the region on the texture candidate image corresponding to the position of the polygon on the polygon as a texture (step S606). Note that the texture image pasting part 162 may store the texture-mapped three-dimensional model in the storage part 120.

Next, the texture image pasting part 162 ends the repetitive processing of the number of polygons of the plurality of polygons (step S607). That is, the texture is pasted to the polygon visible from the position of the camera 301 in the selected texture candidate image by the loop processing of steps S604 to S606. After the processing of steps S604 to S606 is performed on all the plurality of polygons, the processing proceeds to step S608.

Note that, in step S603, when selecting one polygon among the plurality of polygons, the texture image pasting part 162 does not select a polygon to which texture is already pasted. The texture image pasting part 162 selects one polygon that is unselected and to which no texture is pasted among the plurality of polygons.

Next, the texture image pasting part 162 ends the repetitive processing of the number of images of the plurality of texture candidate images (step S608). That is, the texture is pasted to the plurality of polygons constituting the mesh data of the selected three-dimensional model by the loop processing of steps S603 to S607. After the processing of steps S603 to S607 is performed on all of the plurality of texture candidate images, the texture image pasting processing ends.

FIG. 23 is a diagram for describing texture image pasting processing executed by the texture image pasting part 162 included in the three-dimensional model generation device 100 according to the first embodiment.

For example, the texture image pasting part 162 selects one texture candidate image 621 among the acquired plurality of texture candidate images 621 to 624. The texture image pasting part 162 selects one of the plurality of polygons constituting acquired mesh data 631. The texture image pasting part 162 determines whether or not the selected polygon is visible from a position P1 of the camera 301 of the selected texture candidate image 621. That is, the texture image pasting part 162 determines whether or not the selected polygon is included in the capturing range 632 from the position P1 of the camera 301 of the selected texture candidate image 621.

When it is determined that the selected polygon is included in the capturing range 632 from the position P1 of the camera 301 of the selected texture candidate image 621, the texture image pasting part 162 determines whether or not the region on the texture candidate image 621 corresponding to the position of the polygon is a region that has not been subjected to the mask processing. Then, when it is determined that the region on the texture candidate image 621 corresponding to the position of the polygon is a region that has not been subjected to the mask processing, the texture image pasting part 162 pastes the image of the region on the texture candidate image 621 corresponding to the position of the polygon on the polygon as a texture.

Further, when the texture candidate image 624 is selected, the texture image pasting part 162 selects one polygon among the plurality of polygons constituting the acquired mesh data 631, and determines whether or not the selected polygon is visible from the position P2 of the camera 301 of the selected texture candidate image 624. That is, the texture image pasting part 162 determines whether or not the selected polygon is included in the capturing range 633 from the position P2 of the camera 301 of the selected texture candidate image 624.

When it is determined that the selected polygon is included in the capturing range 633 from the position P2 of the camera 301 of the selected texture candidate image 624, the texture image pasting part 162 determines whether or not the region on the texture candidate image 624 corresponding to the position of the polygon is a region that has not been subjected to the mask processing. Then, when it is determined that the region on the texture candidate image 624 corresponding to the position of the polygon is a region that has not been subjected to the mask processing, the texture image pasting part 162 pastes the image of the region on the texture candidate image 624 corresponding to the position of the polygon on the polygon as a texture.

The texture image pasting part 162 pastes the image of the region on the plurality of texture candidate images 621 to 624 corresponding to the position of each of the plurality of polygons constituting the mesh data 631 as a texture on each of the plurality of polygons.

A texture is pasted to each of the plurality of polygons constituting the three-dimensional model 641 illustrated in FIG. 23. The texture image pasting part 162 generates the texture-mapped three-dimensional model 641.

[Effects and the like]

As described above, the three-dimensional model generation method according to the first embodiment is a three-dimensional model generation method in a computer, and includes generating point cloud data of a three-dimensional model indicating a three-dimensional shape of a subject on the basis of a plurality of images arranged in ascending order of distance from the position of the camera 301 to the subject (step S108), generating mesh data from the point cloud data (step S109), generating a plurality of texture candidate images to be pasted to a plurality of polygons constituting the mesh data on the basis of an image in which distances between the plurality of polygons constituting the mesh data and the image are shortest among images having pixel regions corresponding to the mesh data (step S110), and pasting an image of a region on the plurality of texture candidate images corresponding to a position of each of the plurality of polygons as a texture to each of the plurality of polygons (step S111).

With this method, the plurality of texture candidate images to be pasted to the plurality of polygons constituting the three-dimensional model is generated on the basis of the plurality of images arranged in ascending order of distance from the position of the camera 301 to the subject. The image captured by the camera 301 closer to the subject has higher accuracy, that is, higher resolution. Thus, a texture with high resolution can be pasted to the plurality of polygons of the three-dimensional model, and accuracy of a texture-mapped three-dimensional model can be improved.

In addition, information at the time of generating the point cloud data is used, so that image selection processing at the time of texture mapping is unnecessary, and the processing amount can be expected to be reduced.

Further, for example, the generation of the plurality of texture candidate images includes generating a texture candidate image in which a region other than the region including the plurality of pixels corresponding to the point cloud in an image used to generate the point cloud data has been subjected to the mask processing.

In this manner, by not using the region that has been subjected to the mask processing on the texture candidate image as the texture and using the region that has not been subjected to the mask processing on the texture candidate image as the texture, the texture to be pasted to the polygon can be easily determined, and the processing time required to select the texture to be pasted to the polygon can be shortened.

Further, for example, the region including the plurality of pixels may be a region surrounded by the plurality of pixels.

In this manner, since a region other than the region surrounded by the plurality of pixels is subjected to the mask processing, the region to be subjected to the mask processing can be easily determined, and the processing time required for the mask processing can be shortened.

Further, for example, the region including the plurality of pixels may be a region surrounded by an edge detected by edge detection of the periphery of the plurality of pixels or a region in a plane estimated by plane estimation of the periphery of the plurality of pixels.

In this manner, an image not only in the region surrounded by the plurality of pixels but also in a peripheral region of the plurality of pixels can be used as a texture, so that the texture can be pasted to more polygons from one texture candidate image, and the processing time for pasting the texture on the plurality of polygons can be shortened.

Further, for example, the mask processing includes processing of making a region other than the region including the plurality of pixels in the image used to generate the point cloud data transparent.

In this manner, by setting the region including the plurality of pixels in the image used to generate the point cloud data to be opaque and setting a region other than the region to be transparent, the mask processing can be easily performed, and the processing time required for the mask processing can be shortened.

Further, for example, the mask processing may include processing of filling a region other than the region including the plurality of pixels in the image used to generate the point cloud data with a predetermined color.

In this manner, by filling the region other than the region including the plurality of pixels in the image used to generate the point cloud data with the predetermined color, the mask processing can be easily performed, and the processing time required for the mask processing can be shortened.

Further, for example, the pasting of the image includes determining whether or not a region on the texture candidate image corresponding to each position of the plurality of polygons has been subjected to the mask processing, and pasting an image of a region determined not to have been subjected to the mask processing as a texture on the polygon.

In this manner, since the image of the region determined not to have been subjected to the mask processing is pasted to the polygon as a texture, the texture to be pasted to the polygon can be easily determined, and the processing time required to select the texture to be pasted to the polygon can be shortened.

Further, for example, the pasting of the image includes determining whether or not each of the plurality of polygons is visible from the position of the camera 301 of the texture candidate image, and pasting an image of a region on the texture candidate image corresponding to the position of the polygon determined to be visible from the position of the camera 301 to the polygon as a texture.

In this manner, since the texture is pasted only to the polygon visible from the position of the camera 301 of the texture candidate image among the plurality of polygons constituting the mesh data, the processing time required to select the texture to be pasted to the polygon can be shortened.

### Second Embodiment

Next, a three-dimensional model generation device according to a second embodiment will be described. Note that, in the description of the second embodiment, substantially the same components as those of the first embodiment are denoted by the same reference numerals, and the description may be partially simplified or omitted.

### [Configuration]

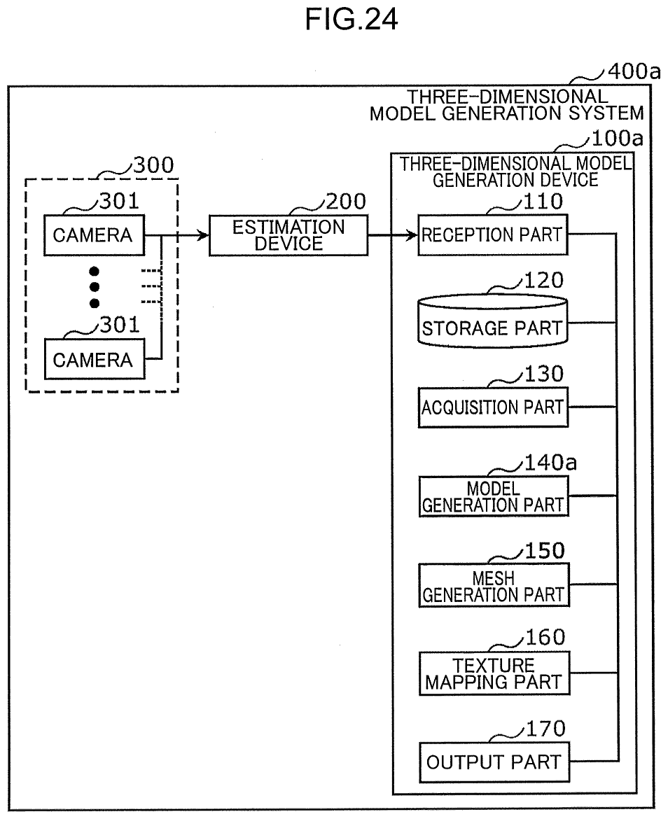

First, a configuration of a three-dimensional model generation device according to the second embodiment will be described with reference to FIG. 24.

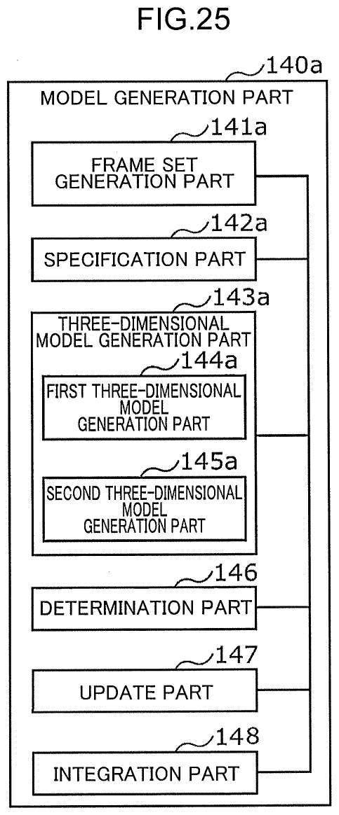

FIG. 24 is a block diagram illustrating a characteristic configuration of a three-dimensional model generation device 100a according to the second embodiment. FIG. 25 is a block diagram illustrating a characteristic configuration of the model generation part 140a included in the three-dimensional model generation device 100a according to the second embodiment.

A three-dimensional model generation system 400a according to the second embodiment includes a camera group 300, an estimation device 200, and a three-dimensional model generation device 100a.

The three-dimensional model generation device 100a includes a reception part 110, a storage part 120, an acquisition part 130, a model generation part 140a, a mesh generation part 150, a texture mapping part 160, and an output part 170.

The model generation part 140a includes a frame set generation part 141a, a specification part 142a, a three-dimensional model generation part 143a, a determination part 146, an update part 147, and an integration part 148.

The frame set generation part 141a is a processing part that determines a frame order of a plurality of frames and generates a frame set. Here, the frame set generation part 141a generates a frame set while maintaining the frame order stored in the storage part 120, that is, while maintaining the capturing order by the camera 301.

The specification part 142a is a processing part that projects an image onto an existing three-dimensional model in the order of frame sets generated by the frame set generation part 141a. The specification part 142a projects a first three-dimensional model on at least one second frame, and specifies a plurality of projected pixels on which the first three-dimensional model is projected in at least one second frame. Specifically, the specification part 142a projects the first three-dimensional model onto at least one second frame that is a frame included in a plurality of frames (more specifically, the frame set) excluding the first frame, and specifies projected pixels that are pixels of one or more second frames onto which the first three-dimensional model is projected and pixels of the first three-dimensional model projected onto one or more second frames. That is, the specification part 142a specifies the projected pixel on which the first three-dimensional model is projected with respect to the frame on which the first three-dimensional model is projected. In addition, the specification part 142a specifies pixels (that is, the three-dimensional point) of the first three-dimensional model projected on the frame.

In addition, the specification part 142a specifies a plurality of unprojected pixels on which the first three-dimensional model has not been projected in at least one second frame.

The three-dimensional model generation part 143a is a processing part that generates a three-dimensional model from a plurality of frames. The three-dimensional model generation part 143a includes a first three-dimensional model generation part 144a and a second three-dimensional model generation part 145a.

The first three-dimensional model generation part 144a is a processing part that generates a first three-dimensional model of a predetermined region from a plurality of first frames. Specifically, the first three-dimensional model generation part 144a generates the first three-dimensional model of the subject from at least two or more first frames which are frames among the plurality of frames.

The second three-dimensional model generation part 145a is a processing part that generates the second three-dimensional model on the basis of the plurality of unprojected pixels specified by the specification part 142a.

The determination part 146 is a processing part that determines whether or not at least one second capturing position where at least one second frame is captured is closer to a predetermined region than any of a plurality of first capturing positions where the plurality of first frames is captured. Specifically, the determination part 146 determines whether or not the position of the camera 301 in which at least one second frame including the projected pixel specified by the specification part 142a is captured is closer to the subject than the position of the camera 301 when a frame used to generate the pixels specified by the specification part 142a and the pixels of the first three-dimensional model is captured. That is, for pixels projected on the existing three-dimensional model in the frame projected by the specification part 142a, the determination part 146 determines which of distances is closer between the subject and the cameras 301 that have captured respective frames of a frame including pixels of the existing three-dimensional model corresponding to the projected pixels and a frame on which the existing three-dimensional model is projected.

When the determination part 146 determines that at least one second capturing position is closer to the predetermined region than any of the plurality of first capturing positions, the update part 147 updates the first three-dimensional model on the basis of the plurality of projected pixels specified by the specification part 142a. Specifically, the update part 147 updates the first three-dimensional model so as to adopt a pixel (that is, a pixel value before the first three-dimensional model is projected) of the frame captured by the camera 301 closest to the subject determined by the determination part 146 for a pixel in which the positions of the three-dimensional points of the three-dimensional model overlap among respective pixels of the plurality of frames.

For example, when the determination part 146 determines that the position of the camera 301 in which at least one second frame is captured is closer to the subject than the position of the camera 301 when the frame used to generate the pixels of the first three-dimensional model is captured, the update part 147 generates a new three-dimensional model by updating (in other words, changing) the pixels of the first three-dimensional model specified by the specification part 142a to at least one projected pixel of the second frame specified by the specification part 142a. That is, the update part 147 generates the new three-dimensional model using pixels of the frame captured by the camera 301 closer to the subject out of the camera 301 that has captured the frame used to generate the pixels of the existing three-dimensional model and the camera 301 that has captured the frame including the pixels on which the existing three-dimensional model is projected.

For example, the specification part 142a projects the existing three-dimensional model onto a frame on which the three-dimensional model has not yet been projected out of the frame set, and specifies a projected pixel that is a pixel on which the three-dimensional model has been projected in the frame. Here, when the second three-dimensional model generation part 145a has not generated the second three-dimensional model, the existing three-dimensional model is the first three-dimensional model. Further, when the second three-dimensional model generation part 145 generates the second three-dimensional model, the existing three-dimensional model is the second three-dimensional model generated by the second three-dimensional model generation part 145.

The specification part 142a and the three-dimensional model generation part 143a repeatedly project the three-dimensional model onto the frame in the order of the frame set to thereby extract projected pixels on which the existing three-dimensional model is projected and corresponding pixels of the existing three-dimensional model in the frame, and for the extracted pixels, generate the new three-dimensional model with the pixels of the frame captured by the camera 301 closer to the subject, out of the camera 301 that has captured the frame used to generate the pixels of the existing three-dimensional model and the camera 301 that has captured the frame including the projected pixels on which the existing three-dimensional model is projected.

### [Processing Procedure]

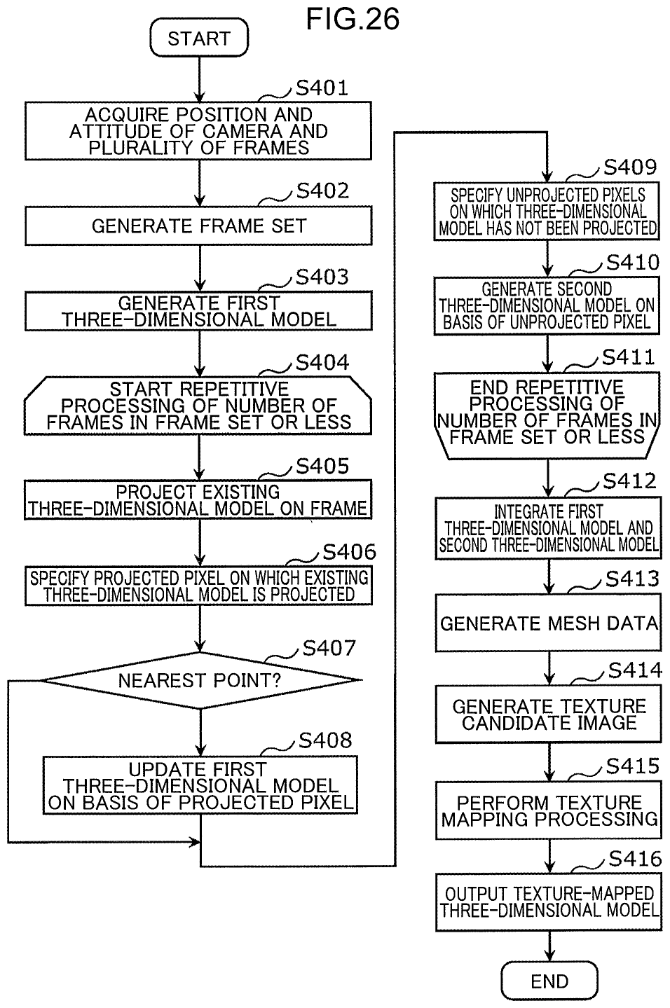

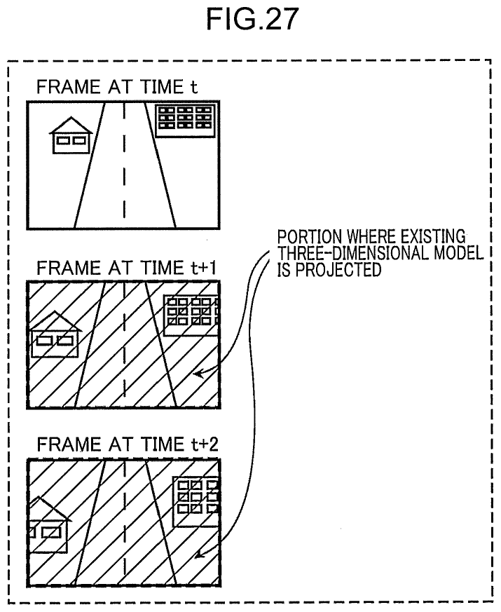

Next, a processing procedure of the three-dimensional model generation device according to the second embodiment will be described in detail with reference to FIGS. 26 and 27.

FIG. 26 is a flowchart illustrating three-dimensional model generation processing executed by the three-dimensional model generation device 100a according to the second embodiment.

First, the acquisition part 130 acquires information indicating the position and attitude of the camera 301, camera parameters, and a plurality of frames from the storage part 120, and inputs them to the model generation part 140a (step S401). Specifically, similarly to the first embodiment, first, the reception part 110 receives information indicating the position and attitude of the camera 301 estimated by the estimation device 200, camera parameters, and a plurality of frames, and outputs these pieces of data to the storage part 120. Further, the storage part 120 stores the information indicating the position and attitude of the camera 301, the camera parameters, and the plurality of frames received by the reception part 110. Then, the acquisition part 130 executes step S401.

Next, the frame set generation part 141a generates a frame set in a frame order that is an order in which the camera 301 has captured the frames (step S402). For example, the camera 301 transmits a captured frame and time information indicating the time of capturing the frame to the three-dimensional model generation device 100a via the estimation device 200 in association with each other. On the basis of the time information associated with each frame, the frame set generation part 141a generates the frame set in the frame order that is an order of frames in which the camera 301 has captured the frames.

Next, the first three-dimensional model generation part 144a generates a three-dimensional model (first three-dimensional model) from the frame set (step S403). For example, the first three-dimensional model generation part 144a generates the first three-dimensional model using any two frames (first frames) in the frame set.

Next, the model generation part 140a starts repetitive processing of the number of frames included in the frame set or less (step S404). Specifically, the model generation part 140a repeatedly executes processing of steps S405 to S410 for each of the plurality of frames included in the frame set.

Next, the specification part 142a projects the existing three-dimensional model onto at least one frame (second frame) in the frame set (step S405).

Next, the specification part 142a extracts pixels on which three-dimensional points of the existing three-dimensional model are projected in the frame on which the existing three-dimensional model is projected (step S406). More specifically, in step S406, the specification part 142a projects the existing three-dimensional model onto at least one or more second frames that are frames included in a frame set excluding the first frame, and specifies a projected pixel of the at least one second frame on which the existing three-dimensional model is projected.

Next, the determination part 146 determines whether or not the projected pixel specified by the specification part 142a in step S406 is the nearest point (step S407). Specifically, the determination part 146 determines whether or not at least one second capturing position where at least one second frame is captured is closer to a predetermined region than any of a plurality of first capturing positions where a plurality of first frames is captured. More specifically, the determination part 146 determines whether or not the position of the camera 301 in which the second frame including the extracted pixels specified by the specification part 142a in step S406 is captured is closer to the subject than the position of the camera 301 when a frame used to generate the pixels specified by the specification part 142a in step S406 and the pixels of the existing three-dimensional model is captured. The determination part 146 determines that a pixel included in a frame captured by the camera 301 closer to the subject is the nearest point.

When the determination part 146 determines that the projected pixel of the second frame specified in step S407 is the nearest point (Yes in step S407), that is, when it is determined that at least one second capturing position is closer to the predetermined region than any of the plurality of first capturing positions, the update part 147 updates the existing three-dimensional model on the basis of the projected pixel before the first three-dimensional model is projected (step S408). That is, the update part 147 updates the pixels of the existing three-dimensional model specified in step S406 to the projected pixels of the second frame specified in step S406.

On the other hand, when the determination part 146 determines that the projected pixel of the second frame specified in step S407 is not the nearest point (No in step S407), the update part 147 does not change the pixel of the existing three-dimensional model to the projected pixel of the second frame. That is, the update part 147 does not perform the processing of updating the pixels of the existing three-dimensional model.

Next, the specification part 142a specifies an unprojected pixel on which the three-dimensional model (specifically, the three-dimensional points constituting the three-dimensional model) has not been projected in the second frame on which the three-dimensional model has been projected (step S409).

Next, the second three-dimensional model generation part 145a newly generates a new three-dimensional model (second three-dimensional model) on the basis of the unprojected pixel specified in step S409 (step S410). That is, the second three-dimensional model generation part 145a generates the second three-dimensional model including points that do not exist in the existing three-dimensional model.

Next, the model generation part 140a ends the repetitive processing of the frame set (step S411).

Next, the integration part 148 integrates the first three-dimensional model and the second three-dimensional model (step S412).

Note that processing of steps S413 to S416 is identical to the processing of steps S109 to S112 illustrated in FIG. 5, and thus description thereof will be omitted.

Note that, in order for the determination part 146 to make the determination in step S407, information indicating the distance between the camera 301 and the three-dimensional points may be held in the frame used to generate the existing three-dimensional model, or the ID of the camera 301 in which a frame including pixels is captured, that is, information indicating the distance between the camera 301 and the subject when the frame is captured may be held in each three-dimensional point (pixel) of the existing three-dimensional model.

FIG. 27 is a diagram for describing a processing position of a frame in processing executed by the update part 147 included in the three-dimensional model generation device 100a according to the second embodiment. Note that, in FIG. 27, the pixel replacement range at time t+1 and time t+2, that is, the pixel position where the existing three-dimensional model is projected in the frame is hatched.

Further, in the example illustrated in FIG. 27, it is assumed that a frame at time t+2, a frame at time t+1, and a frame at time t are close in distance from the subject in this order. First, as illustrated in FIG. 27, for example, it is assumed that the existing three-dimensional model has not been projected at all locations for the frame at time t. In this case, the second three-dimensional model generation part 145a generates the second three-dimensional model for all the pixels of the frame at time t.

Further, as illustrated in FIG. 27, for example, it is assumed that the existing three-dimensional model is projected at a portion indicated by hatching (in the present example, the entirety of the frame at time t+1) for the frame at time t+1. Specifically, it is assumed that the hatched portion in the frame at time t+1 in FIG. 27 is the pixel position where the existing three-dimensional model including the second three-dimensional model generated by the frame at time t in FIG. 27 is projected. In this case, the update part 147 replaces, that is, updates the three-dimensional points (pixels) of the existing three-dimensional model generated (updated) using the frame at time t on which the existing three-dimensional model is projected with the pixels of the frame at time t+1.

Further, as illustrated in FIG. 27, for example, it is assumed that the existing three-dimensional model is projected at a portion indicated by hatching (in the present example, the entirety of the frame at time t+2) for the frame at time t+2. Specifically, it is assumed that the hatched portion in the frame at time t+2 in FIG. 27 is a pixel position (in the present example, the entirety of the frame at time t+2) at which the existing three-dimensional model updated by the frame at time t+1 in FIG. 27 is projected. In this case, the update part 147 replaces the three-dimensional points (pixels) of the existing three-dimensional model with the pixels of the frame at time t+2.

As described above, for example, the update part 147 appropriately updates pixels of the existing three-dimensional model on the basis of the position of the camera 301 that has captured the frame. For example, in a case where the camera 301 advances in the camera optical axis direction (in other words, the positive direction of the reference axis) to capture a scene (subject), the update part 147 replaces the pixels of the existing three-dimensional model with the new three-dimensional model generated in the current processing frame for all the projected points.

Note that, in each of the above embodiments, each constituent element may be implemented by including dedicated hardware or by executing a software program suitable for each constituent element. Each constituent element may be implemented by a program execution part, such as a CPU or a processor, reading and executing a software program recorded in a recording medium such as a hard disk or a semiconductor memory. Further, a program may be recorded onto a recording medium and transferred or transferred via a network, so that the program is performed by another independent computer system.

Some or all functions of the device according to the embodiment of the present disclosure are implemented as large scale integration (LSI), which is typically an integrated circuit. These may be individually integrated into one chip, or may be integrated into one chip so as to include some or all of these. Further, circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the device according to the embodiments of the present disclosure may be implemented by a processor such as a CPU executing a program.

Further, all numbers used above are illustrated to specifically describe the present disclosure, and the present disclosure is not limited to the illustrated numbers.

Further, order in which steps illustrated in the above flowchart are executed is for specifically describing the present disclosure, and may be any order other than the above order as long as a similar effect is obtained. Further, some of the above steps may be executed simultaneously (in parallel) with other steps.

A technique according to the present disclosure is useful as a technique for generating a texture-mapped three-dimensional model since it is possible to paste a texture with high resolution to a plurality of polygons of the three-dimensional model and to improve the accuracy of the texture-mapped three-dimensional model.

1. A three-dimensional model generation method in a computer, the method comprising:
generating point cloud data of a three-dimensional model indicating a three-dimensional shape of a subject on a basis of a plurality of images arranged in ascending order of distance from a position of a camera to the subject;
generating mesh data from the point cloud data;
generating a plurality of texture candidate images to be pasted to a plurality of polygons constituting the mesh data on a basis of an image in which distances between the plurality of polygons constituting the mesh data and the image are shortest among images having pixel regions corresponding to the mesh data; and
pasting an image of a region on the plurality of texture candidate images corresponding to a position of each of the plurality of polygons as a texture to each of the plurality of polygons.

2. The three-dimensional model generation method according to claim 1, wherein the generating the plurality of texture candidate images includes generating a texture candidate image in which a region other than a region including a plurality of pixels corresponding to a point cloud in an image used to generate the point cloud data has been subjected to mask processing.

3. The three-dimensional model generation method according to claim 2, wherein the region including the plurality of pixels is a region surrounded by the plurality of pixels.

4. The three-dimensional model generation method according to claim 2, wherein the region including the plurality of pixels is a region surrounded by an edge detected by edge detection of peripheries of the plurality of pixels or a region in a plane estimated by plane estimation of peripheries of the plurality of pixels.

5. The three-dimensional model generation method according to claim 2, wherein the mask processing includes processing of making a region other than a region including the plurality of pixels in the image used to generate the point cloud data transparent.

6. The three-dimensional model generation method according to claim 2, wherein the mask processing includes processing of filling a region other than a region including the plurality of pixels in the image used to generate the point cloud data with a predetermined color.

7. The three-dimensional model generation method according to claim 2, wherein the pasting the image includes determining whether or not the region on the texture candidate images corresponding to the position of each of the plurality of polygons has been subjected to the mask processing, and pasting an image of the region determined not to have been subjected to the mask processing as the texture on the polygon.

8. The three-dimensional model generation method according to claim 1, wherein the pasting the image includes determining whether or not each of the plurality of polygons is visible from the position of the camera in the texture candidate image, and pasting an image of a region on the texture candidate image corresponding to a position of the polygon determined to be visible from the position of the camera as the texture on the polygon.

9. A three-dimensional model generation device comprising:
a three-dimensional model generation part that generates point cloud data of a three-dimensional model indicating a three-dimensional shape of a subject on a basis of a plurality of images arranged in ascending order of distance from a position of a camera to the subject;
a mesh data generation part that generates mesh data from the point cloud data;
a texture candidate image generation part that generates a plurality of texture candidate images to be pasted to a plurality of polygons constituting the mesh data on a basis of an image in which distances between the plurality of polygons constituting the mesh data and the image are shortest among images having pixel regions corresponding to the mesh data; and
an image pasting part that pastes an image of a region on the plurality of texture candidate images corresponding to a position of each of the plurality of polygons as a texture to each of the plurality of polygons.

10. A non-transitory computer readable recording medium storing a three-dimensional model generation program causing a computer to function to:
generate point cloud data of a three-dimensional model indicating a three-dimensional shape of a subject on a basis of a plurality of images arranged in ascending order of distance from a position of a camera to the subject;
generate mesh data from the point cloud data;
generate a plurality of texture candidate images to be pasted to a plurality of polygons constituting the mesh data on a basis of an image in which distances between the plurality of polygons constituting the mesh data and the image are shortest among images having pixel regions corresponding to the mesh data; and
paste an image of a region on the plurality of texture candidate images corresponding to a position of each of the plurality of polygons as a texture to each of the plurality of polygons.
